(19) United States
(12) Patent Application Publication
(10) Pub. No.: US 2009/0218521 A1
(43) Pub. Date: Sep. 3, 2009

(54) Gaseous neutral density filters and related methods

(75) Inventors: Michael R. Sogard, Menlo Park, CA (US); Hiroyuki Kondo, Saitama (JP)

Correspondence Address: KLARQUIST SPARKMAN, LLP, 121 SW SALMON STREET, SUITE 1600, PORTLAND, OR, 97204, US

(73) Assignee: Nikon Corporation

(21) Appl. No.: 12/322,838

(22) Filed: Feb. 6, 2009

Related U.S. Application Data
(60) Provisional application No. 61/065,106, filed on Feb. 8, 2008.

(51) Int. Cl. G01J 3/10; G21K 1/00

(52) U.S. Cl. 250/504 R; 250/505.1

(57) ABSTRACT

Gaseous neutral density (ND) filters are disclosed that produce a stream of gas to interact with and thereby attenuate a beam of extreme ultraviolet (EUV) radiation. The gaseous ND filter can be located in a system that receives the beam of EUV radiation from an EUV source and delivers the beam to a downstream EUV optical system, wherein the beam passes through the gaseous ND filter between the source and the optical system. The stream of gas used in the gaseous ND filter can be discharged at a supersonic velocity and the gas can be a single gas or a mixture of gases. An exemplary mixture of gases includes xenon and argon gases.

### CROSS-REFERENCE TO RELATED APPLICATION

This application claims the benefit of, and priority to, U.S. Provisional Application No. 61/065,106, filed Feb. 8, 2008, which is incorporated herein by reference in its entirety.

### FIELD

This disclosure pertains to, inter alia, sources of extreme ultraviolet (EUV) light and exposure systems including or otherwise associated with such sources. The subject exposure systems include, but are not limited to, lithography systems as used for fabricating microelectronic devices such as integrated circuits and displays. More specifically, the disclosure pertains to optical filters and optical attenuators that are used with such sources, as well as optical systems for controlling an exposure dose from an EUV source.

### BACKGROUND

Among several candidate “next-generation lithography” technologies for use in the manufacture of semiconductor integrated-circuit devices, displays, and other highly miniaturized devices is “extreme ultraviolet lithography” (EUVL). EUVL is lithography performed using wavelengths of electromagnetic radiation in the range of 11 to 14 nm, which is within the “extreme ultraviolet” or “soft X-ray” portion of the electromagnetic spectrum. EUVL offers prospects of greater image resolution than currently obtainable using “optical” lithography, of which the wavelengths currently in use are greater than those of EUV radiation.

A current challenge in the development of a practical EUVL system is providing a convenient source of EUV exposure “light” capable of providing an EUV beam at sufficient intensity at the desired wavelength for making lithographic exposures at an acceptable throughput. The most powerful source of EUV light currently available is synchrotron radiation. Unfortunately, very few fabrication plants at which EUVL would be performed have access to a synchrotron, which is extremely large and extremely expensive to install and operate. As a result, substantial research and development effort is currently being directed to the development of alternative sources of EUV light. The two principal approaches in this development involve the production of a plasma of a target material, wherein the plasma produces EUV radiation. In one method the plasma is produced by electrical discharge in the vicinity of the target material, and in the other method the plasma is produced by laser irradiation of the target material. The EUV radiation produced by both methods is pulsed. Whereas these methods have advantages of portability as well as relatively compact size and low cost of operation (especially relative to a synchrotron), they have several disadvantages. One disadvantage is the difficulty of producing a sufficiently intense beam of EUV light at the desired wavelength for desired high-throughput exposures. Another disadvantage is that the respective plasmas produced by these sources tend to generate gases and fine debris that deposit on nearby components, especially nearby optical components. In view of the extremely high performance demanded of EUV-optical elements, significant contamination of them by debris and gases from the EUV source simply cannot be tolerated. Another disadvantage is the radiation generated at wavelengths other than the desired EUV, referred to as out of band or OOB. This radiation can represent a significant additional thermal burden to the EUV optics as well as possibly affecting the photoresist.

Because no materials are known that are sufficiently transmissive and refractive to EUV light to serve as EUV lenses, EUV optics comprise reflective optical elements (e.g., mirrors). Except for grazing-incidence mirrors, all EUV mirrors have a respective surficial multilayer film that provides the mirror surfaces with a useful reflectivity to incident EUV light. For EUVL, these mirrors must be fabricated to extremely demanding tolerances and must exhibit extremely high optical performance.

Since EUV light is greatly attenuated and scattered by the atmosphere, the propagation pathway for EUV radiation in an EUVL system is evacuated to a vacuum. This requires that the EUVL optics (e.g., illumination optics and projection optics) be contained in at least one vacuum chamber that is evacuated to a desired vacuum level. Similarly, a plasma EUV source as summarized above is contained in a vacuum chamber (termed an “EUV-source chamber” or a “source chamber”) that is evacuated to a desired vacuum level. Hence, EUV light generated by the plasma EUV source must propagate from the EUV-source chamber to the chamber containing the EUVL optics (e.g., illumination unit chamber).

In the plasma EUV source, EUV light and other wavelengths of light produced by the plasma are collected into a beam. Light collection can be achieved using, for example, one or more collector mirrors situated near the plasma. From the collector mirror(s), the beam passes through an intermediate focus plane of the collector mirror(s), between the source and downstream EUV optics. From the intermediate focus plane the beam is directed as an “illumination beam” to an illumination unit (“illumination-optical system”) contained in an illumination-unit chamber. The illumination-optical system, which is part of the EUVL optics, comprises various mirrors that collectively direct, shape, and condition the illumination beam as required for illumination of a pattern-defining reticle or other “pattern master” situated downstream of the illumination-optical system. Along this beam path the beam typically passes through a spectral filter apparatus which blocks out-of-band radiation (e.g., radiation that is not of the desired EUV wavelengths). The spectral filter apparatus may be located near the intermediate focus plane, or it may be located within the illumination-optical system. The spectral filter apparatus may be a zirconium window, for example, or a gaseous spectral purity filter such as those discussed in U.S. patent application Ser. No. 11/339,119, which is incorporated herein by reference in its entirety.

Downstream from the reticle, projection optics may collect the patterned beam and relay the beam to a wafer. In this manner, the reticle and wafer are illuminated with EUV light, and images of the reticle pattern are projected onto the wafer surface. The imaged wafer is then developed to generate a resulting pattern of features on the wafer surface. The feature size and fidelity with which the resulting pattern matches a target pattern depend on both the intensity and the duration of the EUV exposure, commonly referred to as an exposure dose. For instance, by changing an exposure dose that illuminates a reticle in a lithography system, a resulting feature size can be adjusted. Therefore, typical EUVL systems include an apparatus or mechanism for controlling the exposure dose such as by adjusting the radiation intensity and/or duration. For example, for a pulsed source, dose can be controlled by regulating a number of pulses relayed to the wafer and by regulating the intensity of individual pulses.

A conventional method of dose control includes using material neutral density filters to modify the illumination intensity. Material neutral density filters typically include a sheet of solid or rigid material such as glass, and light is partially attenuated as it is transmitted through the material. Material filters have several disadvantages when used in an EUVL system. For example, the high radiation intensities produced in commercial EUVL tools are likely to damage the filters, thereby increasing dose uncertainty and decreasing system reliability. Furthermore, depending upon the nature of any debris-mitigation system upstream of the filter, the material filter may be vulnerable to erosion or deposition damage as well as to additional heating from particles emitted from a plasma source. Also, dose control may require exchanging or swapping of filters, which reduces throughput and can be difficult or impractical to implement in a commercial EUVL system.

Whereas the conventional dose-control systems summarized above may have utility in the laboratory-scale EUVL systems developed to date, which have been operated with relatively low-intensity EUV beams, conventional filters may fail when subjected to the substantially higher-power EUV beam produced in the near future by a commercial-scale EUVL system. Thus, there is a need for dose-control mechanisms such as gaseous neutral density filters that do not have the many disadvantages of conventional dose-control systems.

### SUMMARY

The needs articulated above, and other advantages are provided, by various aspects of the subject invention, as described herein.

According to a first aspect, devices are provided for attenuating a beam of electromagnetic radiation. An embodiment of such a device comprises a gas-discharge portion and a gas-radiation interaction region. The gas-discharge portion is pneumatically coupled to a source of a filter gas. The filter gas comprises a first attenuating gas that attenuates a wavelength(s) of the electromagnetic radiation, and the gas-discharge portion is configured to produce a stream of the filter gas through which the beam can pass. The gas-radiation interaction portion is coupled to the gas-discharge portion so that the interaction portion receives the stream of the filter gas. By way of example, the gas-radiation interaction portion can be a housing or analogous structure in which the beam traverses the stream and thus is attenuated by the stream.

Desirably, the gas-discharge portion comprises a nozzle that is directed to discharge the filter gas into the gas-radiation interaction portion. For example, the nozzle extends into the interaction region. Under some conditions the nozzle discharges the stream of filter gas at a sub-sonic velocity. Under other conditions, especially in which the beam is of very high intensity (that would heat the gas), the nozzle is configured to discharge the stream at a supersonic velocity through the interaction portion. The high velocity ensures that a particular portion of the stream of gas has traversed the interaction portion before the portion experiences significant heating by the radiation. Exemplary supersonic nozzles are bell nozzles and “aerospike” nozzles. Desirably, the wall of the supersonic nozzle is temperature controlled, cooled and/or heated as required to maintain the wall within a preselected temperature range.

Generally, the beam of electromagnetic radiation propagates along a first axis extending into the interaction portion. Desirably, the beam axis is perpendicular to the longitudinal axis of the filter-gas stream as the stream enters the interaction portion. Further desirably, the beam has an intermediate focus plane that is situated in the filter-gas stream as the beam passes through the stream. Furthermore, the stream of filter gas desirably is dimensioned such that substantially all the beam passes through the stream in the interaction portion.

The filter gas can consist entirely of the first attenuating gas or can comprise a mixture of the first attenuating gas and one or more other attenuating gases, or a mixture of the first attenuating gas and at least one “transmitting gas” that transmits rather than attenuates the wavelength. These constituent gases can be supplied by a gas-source portion that is pneumatically coupled to the gas-discharge portion, wherein the gas-source portion comprises a respective adjustable source of each of the gases in the filter gas.

The gas-discharge portion can further comprise a mixing chamber in which constituent gases are received and the filter gas (a mixture of gases including the first attenuating gas) is prepared and conditioned (e.g., brought to a desired pressure, temperature, concentration, or the like) for producing the stream. Desirably, the respective amounts of the constituent gases entering the mixing chamber are measured and monitored. One way of measuring and monitoring is based on the respective partial pressures of the gases in the mixing chamber. To such end, a partial-pressure analyzer, coupled to the mixing chamber and sensitive at least to the first and second gases, can be used. The partial-pressure analyzer can supply partial-pressure data to a controller connected to devices (e.g., valves) that introduce the respective gases to the mixing chamber, thereby establishing, at least, predetermined partial pressures of the first and second gases in the mixture in the mixing chamber in response to the data. Other measuring and/or monitoring devices include temperature-monitoring devices, concentration-measuring devices, and the like. The mixing chamber can include a heater and/or cooler and temperature sensor to regulate the temperature of the filter gas.

A pressure chamber desirably is coupled downstream of the mixing chamber. If the gas-discharge portion comprises a nozzle, the nozzle can be coupled to the pressure chamber and configured to produce the stream of filter gas as filter gas in the pressure chamber is discharged from the nozzle. In some embodiments the pressure chamber is configured as a stagnation chamber upstream of the nozzle to achieve a stagnation condition of the filter gas just before the gas is discharged by the nozzle.

In other embodiments the mixing chamber comprises first and second chambers that are connected to respective sources of gas and have respective monitoring devices. For example, the first chamber can be configured to receive the first gas, and a separate second chamber can be configured to receive the second gas. Both chambers are pneumatically coupled to a pressure chamber. The first and second chambers each comprise a respective partial pressure analyzer, or analogous device. The analyzers are sensitive to the first and second gases, respectively, and are operable to determine respective partial pressures of the first and second gases, respectively, in the respective first and second chambers for delivery to the pressure chamber.

The filter device can further comprise a gas-collection portion coupled to the interaction portion to collect gas of the stream that has passed through the interaction portion. The gas-collection portion can include, for example, a vacuum pump.

The filter device can be used with a beam of electromagnetic radiation of which at least one wavelength of electromagnetic radiation is an EUV wavelength. In such embodiments the first attenuating gas attenuates the at least one EUV wavelength, wherein at least a portion of the EUV wavelength is attenuated by passage of the beam through the stream. An example EUV-attenuating gas is xenon gas, and example EUV-transmitting gases are argon, helium, neon, krypton, and mixtures of at least two of these gases.

If the flow of filter gas in the stream is supersonic in the interaction portion, a shock wave may be produced in the stream. In such embodiments the interaction portion can include at least one feature (e.g., a wall or analogous structure) situated relative to the stream and configured to displace the shock wave from the beam so that the beam passing through the stream does not encounter the shock wave.

In addition to its function as a radiation-attenuating device, as summarized above, the device also can be used as a gas curtain for reducing downstream propagation (e.g., in the beam-propagation direction) of contaminants. Example contaminants are, but are not limited to, debris and/or contaminant gases produced by a source of the electromagnetic beam (e.g., an EUV source). The gas stream produced by the gas-discharge portion entrains and deflects contaminants, entering the interaction portion with the beam from upstream, away from the beam, thereby preventing propagation of the contaminants downstream with the beam. If the device includes a gas-recovery portion, the deflected contaminants are readily scavenged and removed.

Also provided are gaseous filter devices for attenuating a beam of electromagnetic radiation including EUV light. An embodiment of such an apparatus comprises a first mixing chamber coupled to receive a first gas that attenuates propagation of EUV light. A partial pressure analyzer connected to the first mixing chamber produces data indicative of a respective partial pressure of at least the first gas in the first mixing chamber. A controller receives the data from the partial pressure analyzer and regulates input of at least the first gas into the first mixing chamber based on the data to produce a selected mixture of gases in the first mixing chamber. A gas-discharge nozzle is coupled to the first mixing chamber so as to receive the mixture of gases from the first mixing chamber and to discharge a flow of the gas mixture (at, e.g., supersonic velocity) such that the beam of electromagnetic radiation passes through the discharged flow. At least some of the EUV light of the beam is attenuated by passage of the beam through the discharged flow.

If desired, first and second gas-delivery sensors can be connected to the partial pressure analyzer to sense delivery of first and second gases, respectively, to the first mixing chamber. The data produced by the partial pressure analyzer are based on respective gas deliveries sensed by the first and second gas-delivery sensors. Based on the data, respective amounts of the first and second gases to be delivered to the mixing chamber are determined using, for example, the controller.

If desired, the mixing chamber can include a heater and/or cooler. A residual gas analyzer can be used to produce data used by a controller to regulate the heater and/or cooler to produce the selected gas mixture having at least a selected temperature. The mixing chamber of this embodiment desirably comprises a temperature sensor, wherein the heater/cooler receives data from the temperature sensor. In cooperation with the temperature sensor, the heater/cooler regulates the temperature of the gas mixture in the mixing chamber.

The device can include a pressure chamber coupled downstream of the mixing chamber to receive the gas mixture from the mixing chamber. The pressure chamber is connected to the gas-discharge nozzle and delivers the gas mixture to the gas-discharge nozzle. The pressure chamber can be configured to provide a stagnation condition of the mixture of gases before the mixture enters the gas-discharge nozzle.

The number of mixing chambers is not limited to one. Two or more mixing chambers can be used, each connected to receive a respective one or more gases. For example, the first mixing chamber receives an EUV-attenuating gas, and a second mixing chamber receives an EUV-transmissive gas. Desirably, each mixing chamber has a respective temperature-control device to heat and/or cool the respective gas(es) in the mixing chambers. The mixing chambers are coupled to the nozzle, either directly or, desirably, with an intervening pressure chamber. The pressure chamber receives respective gas(es) from the mixing chambers to produce a desired filter-gas mixture at a desired pressure for delivery to the nozzle. An example EUV-attenuating gas is xenon, and example EUV-transmissive gases are argon, helium, neon, krypton, and mixtures thereof). If desired or necessary, a gas-collection device (comprising, e.g., a vacuum pump) can be situated downstream of the gas-discharge nozzle to collect gas discharged by the nozzle.

According to another aspect, EUV optical systems are provided. An embodiment thereof comprises a first optical system portion situated relative to a source and configured to route an EUV-containing light beam from the source. A gaseous neutral density (ND) filter is located relative to the first optical system portion to receive the beam from the first optical system portion. The gaseous ND filter comprising a gas-discharge portion and a gas-radiation interaction portion as summarized above. The optical system can further comprise a second optical system portion situated to receive the attenuated beam and to direct the attenuated beam to a downstream reticle or the like.

According to yet another aspect, sources of EUV light are requested. An embodiment of such a source comprises a generating device that generates EUV-containing light, and a gaseous ND filter situated downstream from the generating device. The ND filter comprises a chamber and gas-discharging nozzle. The chamber is connected to a source of an EUV-attenuating gas to receive the EUV-attenuating gas from the source and to discharge a stream of the EUV-attenuating gas from the nozzle into the chamber. The EUV-attenuating gas is discharged in a direction allowing the EUV-containing light from the generating device to pass through the stream and be attenuated by the stream. If desired the chamber is also connected to a source of EUV-transmissive gas, wherein the EUV-attenuating gas as discharged from the nozzle is mixed with the EUV-transmissive gas.

According to yet another aspect, methods are provided for producing a dose of electromagnetic radiation. An embodiment of such a method includes generating a beam of electromagnetic radiation comprising EUV light. A stream of a gas comprising an EUV-attenuating gas is produced, and the beam is passed through the stream of gas to attenuate at least a portion of the EUV light of the beam and thereby produce a first dose of the electromagnetic radiation. The method can include using the gas stream to entrain and remove contaminants approaching the stream from an upstream source.

If desired, producing the stream includes producing a first gas mixture comprising a first controlled amount of the EUV-attenuating gas and a first controlled amount of at least one EUV-transmissive gas (the first controlled amounts being appropriate for providing a first attenuation of the EUV of the beam). The first gas mixture is discharged through the nozzle as a stream of gas. The beam is passed through the stream of gas to produce the first dose of the electromagnetic radiation. A second gas mixture also can be produced that comprises a second controlled amount of the EUV-attenuating gas and a second controlled amount of at least one EUV-transmissive gas, wherein the second controlled amounts are appropriate for providing a second attenuation of the EUV of the beam. The second gas mixture is discharged as a stream through the nozzle, and the beam is passed through the stream to produce a second dose of the electromagnetic radiation.

The foregoing and other objects, features, and advantages of the invention will become more apparent from the following detailed description, which proceeds with reference to the accompanying drawings.

### BRIEF DESCRIPTION OF THE DRAWINGS

FIG. 1(A) is a schematic showing certain aspects of an embodiment of a gaseous neutral density filter apparatus and of a downstream illumination unit.

FIG. 1(B) is a cross-sectional view along the line B-B of the exemplary gas stream illustrated in FIG. 1(A).

FIG. 1(C) shows simulated profiles of gas density along the direction B-B, evaluated at several distances from the discharge nozzle.

FIG. 2 is a plot of transmission versus wavelength for several gases at a temperature of 295 K, a pressure of 100 Pa, and for a 0.1 m transmission path length.

FIG. 3 is a plot of gas pressure versus EUV transmission as exhibited by xenon, argon, and helium gases at 295 K.

FIG. 4 is a plot of gas pressure versus EUV transmission as exhibited by a mixture of argon and xenon gases at a temperature of 295 K, a total pressure of 73.2 Pa, and for a 0.1 m transmission path length.

FIG. 5 is a plot of gas pressure versus EUV transmission as exhibited by xenon gas a 295 K for two transmission path lengths, 1.0 and 0.1 m.

FIG. 6 is a schematic of a first representative embodiment of a gas-discharge portion of a gaseous neutral density filter apparatus.

FIG. 7 is a schematic of a second representative embodiment of a gas-discharge portion of a gaseous neutral density filter apparatus.

FIG. 8(A) is a cross-sectional view of a first representative embodiment of an interaction chamber in a gaseous neutral density filter apparatus.

FIG. 8(B) is an illustration of the envelope of the portion of the EUV beam 851 illustrated in FIG. 8(A) that interacts with the stream of ND filter gas 854.

FIG. 8(C) is a cross-sectional view of the EUV beam 851 indicating a diameter of the beam at the intermediate focus and a diameter of the beam at an edge of the ND filter gas stream 854.

FIG. 9 is a density graph for gas in the interaction chamber illustrated in FIG. 8(A).

FIG. 10 is a cross-sectional view of second representative embodiment of an interaction chamber in a gaseous neutral density filter apparatus.

FIG. 11 is a density graph for gas in the interaction chamber illustrated in FIG. 10.

FIG. 12 is a flow-chart of a first embodiment of a method for attenuating an EUV beam with a supersonic gas flow.

FIG. 13 is a flow-chart of a second embodiment of a method for attenuating an EUV beam with a supersonic gas flow.

FIG. 14 is a schematic of an embodiment of an interaction chamber receiving an exemplary introduction of a contaminant gas.

FIG. 15(A) includes a plot of gas confinement as a function of y-position when the contaminant gas is helium.

FIG. 15(B) includes a plot of gas confinement as a function of y-position when the contaminant gas is krypton.

FIG. 16 is a schematic elevational view of an EUV lithography system including a gaseous neutral density filter apparatus as disclosed herein.

FIG. 17 is a process-flow diagram illustrating exemplary steps associated with a process for fabricating semiconductor devices.

FIG. 18 is a process-flow diagram illustrating exemplary steps associated with processing a substrate (wafer), as would be performed, for example, in step 1740 in FIG. 17.

FIG. 19(A) is a schematic showing several rays of the EUV beam passing through the ND filter gas stream when the intermediate focus lies approximately at the median plane of the ND filter gas stream.

FIG. 19(B) is a schematic showing several rays of the EUV beam passing through the ND filter gas stream when the intermediate focus is some distance from the median plane of the ND filter gas stream.

### DETAILED DESCRIPTION

### Basic Considerations

This disclosure is set forth in the context of multiple representative embodiments that are not intended to be limiting in any way.

In the following description, certain words are used, such as “upward,” “downward,” “vertical,” “horizontal,” and the like. These words are used to provide clarity of the descriptions when read in the context of the drawings. Whereas these words are useful in understanding relative relationships, they are not intended to be limiting. For example, a device depicted in a drawing readily can be turned upside down, resulting in an “upper” surface becoming a “lower” surface, and vice versa.

As used in this application and in the claims, the singular forms “a,” “an,” and “the” include the plural forms unless the context clearly dictates otherwise. Additionally, the term “includes” means “comprises.” Further, the terms “coupled” and “connected” mean electrically, electromagnetically, pneumatically, or mechanically coupled or linked and does not exclude the presence of intermediate elements between the connected items.

As used herein, a “neutral density filter” is a filter that attenuates or reduces the intensity of radiation over a range of frequencies. The attenuation can be substantially constant across the range of frequencies, or the attenuation can vary as a function of frequency. The range of frequencies can be the range of frequencies generally referred to as “EUV.” However, the range of frequencies can also be a selection of frequencies within the range of frequencies generally referred to as EUV, a range of frequencies not in the EUV range, or a range of frequencies including EUV and other frequencies. The range of frequencies can also refer to radiation of a single frequency such as EUV radiation having a wavelength of 13.5 nm.

A “gaseous” neutral density filter is a neutral density filter consisting of gas, typically flowing gas. Gaseous neutral density (ND) filters offer several advantages over conventional “material” ND filters. For example, a gaseous ND filter can act as a gas curtain to inhibit debris and other particles or gaseous contaminants generated by an upstream source, or otherwise present in an upstream source chamber, from passing into an illumination unit or other chamber downstream of the source chamber. A gaseous ND filter can be continuously replenished through flowing of its constituent gas such that adverse consequences that otherwise would result from heating of and damage to the filter can be reduced or eliminated. Also, because gas flow typically reaches a steady state within a few milliseconds of commencement, gas properties can be rather easily and quickly modified to change and control transmission properties of the gaseous ND filter.

In general, in an EUV system employing a gaseous ND filter, an EUV beam traverses a flow of gas (referred to as the “ND filter gas”) and is attenuated by the ND filter gas. Comparison of the intensity of the EUV beam after traversing the ND filter gas to the beam intensity before encountering the ND filter gas can be used as a measure of transmission, or equivalently of attenuation, of the EUV beam by the gaseous ND filter. Providing of a particular dose of EUV radiation depends on the particular transmission properties of the gaseous ND filter.

The attenuation experienced by the EUV beam can depend on various factors such as the transmission path or region of interaction with the ND filter gas, and properties of the ND filter gas such as composition, temperature, pressure, speed of flow, gas stream geometry, etc. By adjusting one or more of these factors, the transmission properties of the gaseous ND filter and, therefore, an EUV exposure dose downstream of the filter can be controlled. Preferably, the transmission of the gaseous ND filter can be controlled over a large range with low uncertainty. In general, transmission can range from about 1% (i.e., transmitting only 1% of incident EUV light) to about 100% (i.e., transmitting substantially all incident EUV light). Embodiments described herein may be capable of controlling dose range from about 1% transmission to about 100% transmission with a dose certainty (measured as a percentage of a selected transmission setting) of less than about ±5%.

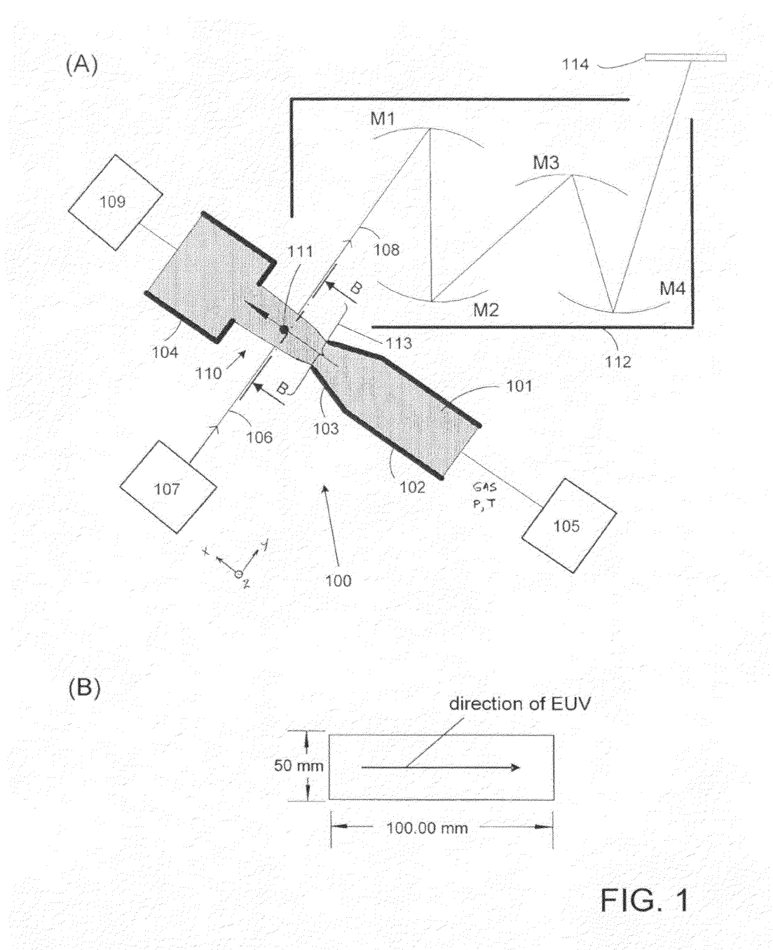

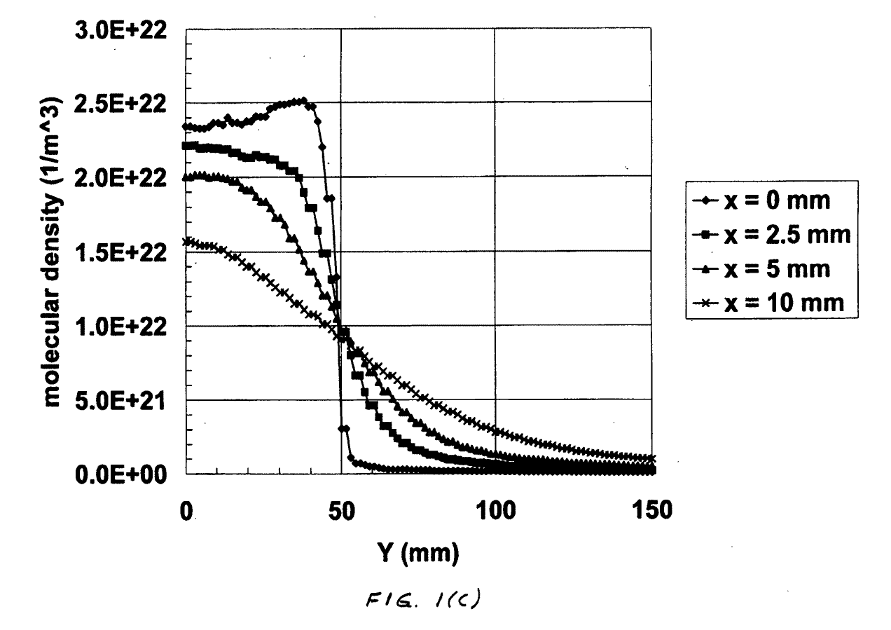

FIG. 1(A) is a schematic showing certain aspects of an embodiment of a gaseous ND filter apparatus 100 and of a downstream illumination unit 112 and reticle 114 of an EUV microlithography system. The gaseous ND filter apparatus 100 comprises a gas-discharge portion 102 and a gas-collection portion 104. The gas-discharge portion 102 includes a gas-discharge device such as a nozzle 103 connected to a source 105 of a ND filter gas 101. The nozzle 103 discharges the ND filter gas 101 as a gas stream 110 to be collected by the gas-collection portion 104. As the gas stream flows from the gas-discharge portion 102 to the gas-collection portion 104, the gas also expands transversely to some extent. This reduces the effectiveness of the gas-collection portion 104 somewhat and increases the pumping burden of the rest of the vacuum system. In FIG. 1(A), an arrow indicates the direction of flow of the gas in the gas stream 110 from the gas-discharge portion 102 towards the gas-collection portion 104. The gas-collection portion 104 can be a vacuum chamber, and, typically, the gas-collection portion 104 includes a pump 109 such as a turbomolecular pump to facilitate gas collection. Cryogenic pumps might also be used. A recycling unit that salvages the gas for re-use may also be desirable.

The depicted illumination unit 112 includes, by way of example, reflective optics M1, M2, M3, M4 for receiving, directing and shaping the EUV beam 108. For example, the optics can include collimating reflective optics, reflective fly's-eye optics, and condensing reflective optics.

An EUV beam 106 from an upstream EUV source 107 traverses the ND filter gas stream 110 within an interaction region 113. The direction of propagation of the EUV beam 106 is indicated by arrows in FIG. 1(A). The interaction region 113 can be contained in an interaction chamber (not shown) and generally refers to the region between the nozzle 103 of the gas-discharge portion 102 and the gas-collection portion 104 where the EUV beam interacts with the gas stream 110 of the gaseous ND filter apparatus 100. As the EUV beam traverses the gas stream 110, the beam is attenuated such that a single frequency or a range of frequencies of radiation of the downstream EUV beam 108 is reduced in intensity relative to corresponding frequencies of the upstream EUV beam 106.

EUV light generated in the source 107 is collected and formed by the source into the upstream EUV beam 106. The upstream EUV beam has an intermediate focus that desirably is positioned at an approximate center 111 of the gas stream 110. This positioning of the intermediate focus typically ensures that non-uniformities or density variations in the gas stream along the direction of the gas flow are approximately equally experienced over the width of the EUV beam and on both sides of the intermediate focus. As a result, attenuation will be substantially the same across the beam width. It is also generally desirable that the EUV beam 106 be positioned substantially orthogonal to the gas stream 110 so that attenuation across the EUV beam will be substantially the same. However, the intermediate focus of the EUV beam 106 need not always be positioned at the center 111 of the gas stream 110, and the EUV beam 106 need not always be perpendicular to the gas stream 110.

The transmission T(x, z) of radiation passing through a gas in the y direction is described by Eq. 1:

$$T ( x , z ) = exp [ - {\int }_{{y}_{1}}^{{y}_{2}} α N ( x , y , z ) d y ] , \qquad ( 1 )$$

where α is the gas-absorption coefficient for the wavelength or spectral range of the radiation, N(x, y, z) is the gas molecular density, and the gas is assumed to lie essentially between y₁ and y₂. In general the gas molecular density will vary in transverse dimensions x and z. If the gas molecular density uniformity is high, the variation in transmission will be small.

The gas molecular density can be related to pressure P and temperature T through the ideal gas law:

PV=NₘₒₗkT, (2)

where k is Boltzmann's constant k=1.3807×10⁻²³ J/K, and Nₘₒₗ is the number of molecules in volume V. The gas molecular density N≡Nₘₒₗ/V is then

N=P/kT, (3)

Hence, the molecular density N can be adjusted by changing either P or T or a combination of P and T.

FIG. 1(B) depicts a cross-sectional view of the exhaust of the nozzle 103. Gas emitted from the nozzle initially has transverse dimensions very similar to the nozzle exhaust dimensions. However, as the gas travels in the chamber vacuum it expands. Density profiles of the gas as a function of distance x from the nozzle exhaust are shown in FIG. 1(C). The profiles are obtained from a two-dimensional (in the x-y plane) simulation of gas flow using a direct simulation Monte Carlo (DSMC) model, such as is available at the website www.gab.com.au, and are intended to be illustrative. The x-direction is along the axis of the gas flow, and the y-direction is along the axis of the EUV radiation. Near the nozzle, the gas profile has dimensions close to those of the nozzle. Farther from the nozzle, the profile becomes more diffuse, making definition of the gas jet size more difficult. The gas stream profile along the line B-B indicated in FIG. 1(A) will resemble one of the curves in FIG. 1(C). To a reasonable approximation however, the EUV transmission as defined in Eq. 1 will not show a large dependence on the gas profile, since the transmission involves an integral along the direction of the EUV beam. Therefore, the portion of the gas stream 1110 that is traversed by the EUV beam 106 may be defined to a reasonable approximation as having exemplary dimensions for the gaseous ND filter apparatus 100 as indicated in FIG. 1(B). This approximation is limited by two effects. If the gas stream expands in the y direction beyond the limits of the integral, y₁ and y₂, the calculated transmission is too large. Additionally, as the gas emerges from the nozzle into the ambient vacuum, the gas speeds up until it encounters the walls of the vacuum chamber, or is slowed by the residual gas in the chamber. This causes the gas density to drop somewhat as it travels from the nozzle. In FIG. 1(A) the EUV beam 106 is substantially perpendicular to the direction of flow of the ND filter gas stream 110. By way of example, in FIG. 1(B) the nozzle 103 is 50 mm wide in a dimension perpendicular to the EUV beam and approximately 100 mm wide in a dimension parallel to the EUV beam. In this example, with the above approximation, the EUV beam experiences an approximately 100 mm long transmission path through the ND filter gas stream 110. In the depicted embodiment, for an EUV beam that is not substantially perpendicular to the direction of flow of the ND filter gas stream, the transmission path will vary from 100 mm. As noted, the dimensions indicated in FIG. 1(B) are merely exemplary, and gaseous ND filter systems as described herein can include gas streams having different dimensions. In general, the dimensions of the stream of ND filter gas are large enough such that all or a majority of the EUV beam 106 will interact with the ND filter gas when the beam traverses the ND filter gas stream 110.

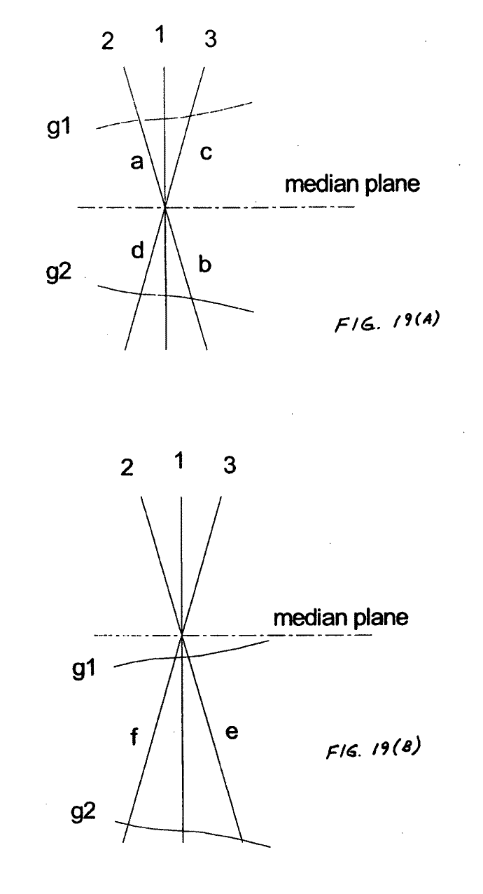

FIG. 19(A) shows several rays of the EUV beam passing through the ND filter gas when the intermediate focus lies close to the median plane of the ND filter stream. Ray 1 is the chief ray, and the EUV transmission is described by Eq. 1. The lines g1 and g2 represent the approximate limits of the gas density and correspond to the values y₁ and y₂ in Eq. 1. Rays 2 and 3 represent rays crossing the intermediate focus at extreme angles relative to the chief ray 1. Their EUV transmissions are given by integral expressions similar to Eq. 1, except that the integration axis is now tilted relative to the y axis. The transmission of ray 2 is determined by integrals over the two segments a and b. The transmission of ray 3 is determined by integrals over the two segments c and d. As illustrated in FIG. 1(C) the density of the gas stream decreases as the distance from the nozzle x increases. It also decreases in the y direction away from the median plane of the nozzle. Therefore, segment a of ray 2 can be expected to contribute more to the attenuation of the beam than segment c of ray 3. On the other hand, segment b can be expected to contribute less attenuation than segment d of ray 3. If the intermediate focus lies close to the median plane, segments a and d should be nearly equal, and segments b and c should be nearly equal. Therefore the transmission of ray 2, given by the sum a+b, should be nearly equal to the transmission of ray 3, given by the sum c+d.

Furthermore, segment a contributes more to the EUV attenuation than the corresponding segment of ray 1, while segment b contributes less than the corresponding segment of ray 1. Therefore the transmission of ray 2, represented by the sum a+b, may be close to that of ray 1, given the symmetry of the gas density surrounding the median plane. Therefore the EUV transmission may be more uniform than might be expected, given the variation of the gas density in x and y. Similar arguments may be given for EUV rays lying in the x-z plane or other azimuthal orientations.

Conversely, FIG. 19(B) shows several rays of the EUV beam passing through the ND filter gas when the intermediate focus lies far from the median plane of the ND filter stream. The EUV transmission for ray 2 now corresponds to the segment e, and the EUV transmission for ray 3 corresponds to the segment f. From the above description of the gas stream properties, we can expect segment e to have higher transmission than the corresponding segment of ray 1. Moreover the transmission of ray 1 can be expected to have higher transmission than that of ray 2. Therefore, the EUV transmission uniformity can be expected to be considerably worse when the EUV intermediate focus is not close to the median plane of the ND filter gas stream.

The ND filter gas used in the gaseous ND filter apparatus 100 can be a single gas or a mixture of gases. In general, the ND filter gas comprises at least one gas that absorbs EUV radiation (also called an “attenuating gas”). Desirably, the ND filter gas includes an attenuating gas that is highly absorbent of EUV radiation. For example, when compared to a gas having a lower EUV absorption, similar EUV attenuation can be achieved with smaller quantities of a highly absorbing gas.

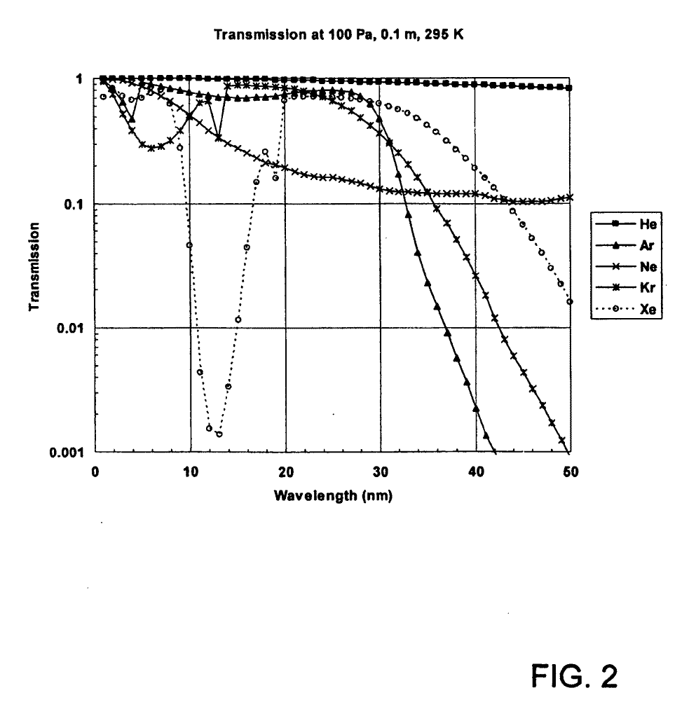

FIG. 2 is a plot of transmission as a function of wavelength (in a representative EUV range) for helium (He), argon (Ar), neon (Ne), krypton (Kr), and xenon (Xe) gases at a pressure of 100 Pa and a temperature of 295 K. The length of the transmission path through the gases is 0.1 m, and a transmission of unity (1) indicates 100% transmission. It is evident from the plot that xenon gas exhibits comparatively high absorption of EUV radiation having a wavelength between about 10 nm and about 15 nm. Accordingly, xenon gas is generally desirable for use as an EUV-attenuating gas in the gaseous ND filter 100. Alternative embodiments of the gaseous ND filter can include one or more attenuating gases other than xenon or in addition to xenon.

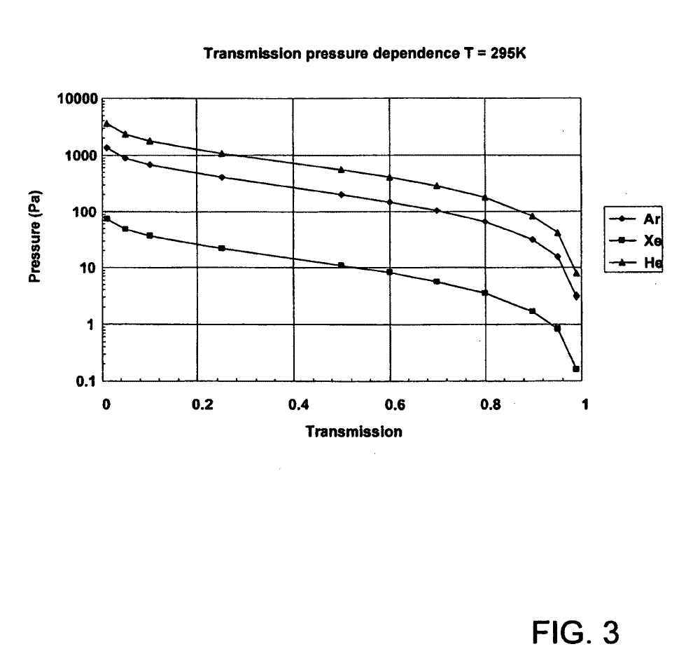

FIG. 3 is a plot of pressure versus transmission of 13.5 nm EUV radiation for argon, xenon, and helium gases at a temperature of 295 K and a transmission path through the gas of 100 mm. As is evident from the plot, argon and helium gases must be at higher pressures than xenon gas to achieve substantially the same transmission obtained with xenon. Therefore, when it is desirable to operate the gaseous ND filter apparatus at a lower pressure, xenon gas is desirable over helium and/or argon gases for use as a ND filter gas. FIG. 3 also indicates that transmission between about 1% and about 100% can be selected by adjusting the respective pressures of argon, xenon, and helium gases. Therefore, the transmission of a gaseous ND filter apparatus 100 can be controlled by adjusting the pressure of the ND filter gas 101 while keeping the temperature constant.

The ND filter gas 101 can also comprise a mixture of attenuating gases or a mixture of one or more attenuating gases with one or more other gases that only weakly attenuate the EUV radiation (also called “transmitting gases”). A mixture of attenuating and transmitting gases allows a total pressure of the gas mixture to be maintained while the concentration of each of the gases in the mixture is separately adjusted to modify EUV transmission properties of the mixture. For example, the ND filter gas 101 can comprise an attenuating gas such as xenon and a transmitting gas such as helium, argon, or other noble gas. When the ND filter gas is a mixture of gases, EUV transmission and gas pressure can be varied somewhat independently. For a mixture of gases, the total pressure, as referred to herein, is the sum of the partial pressures of the individual gases in the mixture. The partial pressure is the pressure that the individual gas in the mixture would have if the individual gas alone was confined to the same volume as the mixture.

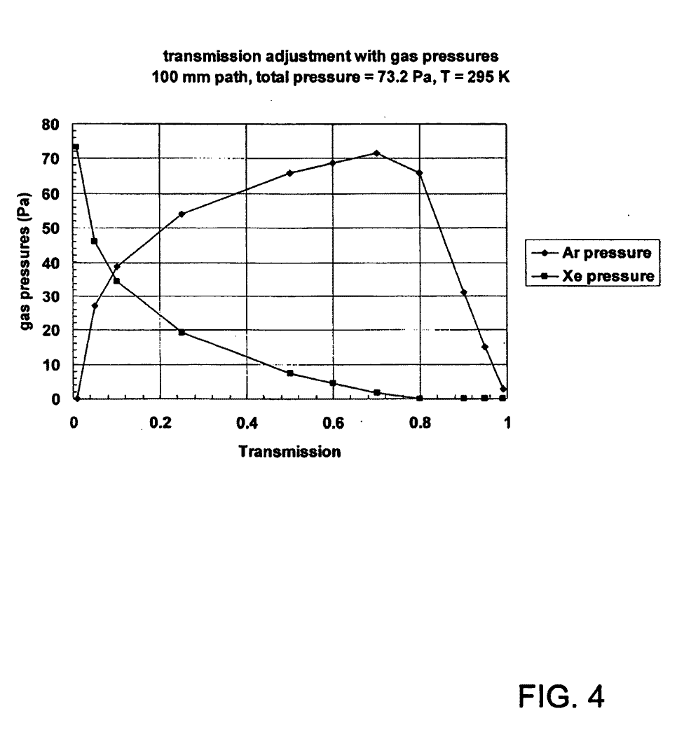

FIG. 4 is a plot of gas pressure versus transmission of 13.5 nm EUV radiation for an argon-xenon gas mixture at a total pressure of 73.2 Pa and a temperature of 295 K for a transmission path of 100 mm. The individual argon and xenon gas pressures are varied in order to achieve a range of transmission levels. The plot indicates that EUV transmission between about 1% and about 80% can be achieved at the selected total pressure. The achievable range of transmission may be modified such as by changing the total pressure, temperature, or both, of the mixture. Above approximately 80% transmission the Xe concentration is reduced to zero, and the Ar pressure is reduced. In this case the total gas pressure is reduced.

In various embodiments of a gaseous ND filter, such as apparatus 100, the temperature of the discharged stream of ND filter gas will increase when exposed to the high-intensity EUV beam. However, allowing an excessive temperature increase of the stream of ND filter gas will alter the transmission properties of the gaseous ND filter system (e.g., by changing the pressure and density of the stream of gas), resulting in less accurate and less reliable dose control. For example, a stream of gas absorbing 0.1 J of EUV radiation in 1 msec (corresponding to 100 W of radiation absorption) will experience an estimated temperature increase of about 2200 K for the dimensions of the gas jet and EUV beam described here. Such a large temperature increase will result in a corresponding significant change in the gas density and, therefore, in the gas transmission properties. Therefore, excessive heating of the stream of ND filter gas by the EUV beam adversely affects the transmission properties of a gaseous ND filter.

To reduce adverse effects of gas heating on the performance of the gaseous ND filter system, gas-flow conditions are controlled. For example, the ND filter gas desirably experiences a temperature increase of less than 100 K from interaction with the EUV beam. In general, the higher the velocity of ND filter gas moving through the EUV beam, the less energy absorbed by a cell of gas and the lower the temperature increase experienced by the ND filter gas. When discharged at supersonic speeds, the ND filter gas will generally pass through the EUV beam fast enough to avoid severe heating. For example, a ND filter gas flow of Mach 2 is often sufficient, though higher speeds such as Mach 4 or faster may be advantageous in some embodiments. When discharging gas from the nozzle at speeds greater than Mach 1, it can be beneficial to have a nozzle configured with a nozzle-wall-heating or a nozzle-wall-cooling mechanism. At such high gas speeds, control of nozzle wall temperature can help maintain desired gas conditions at the nozzle discharge.

At lower beam intensities, subsonic gas flow may be adequate. More conventional neutral density filters may also be effective at the lower intensities, obviating the need for a gaseous neutral density filter. A supersonic flow has another advantage over a subsonic flow. Any change in gas properties from energy absorption cannot propagate upstream, because it will propagate at less than sonic velocity. This insures that when the gas first encounters the EUV it has the initial desired density and minimizes the effects of subsequent heating.

The above comments refer to the case of a continuous EUV source. In fact most EUV sources are pulsed, with the EUV radiation occurring for a small fraction of the time between pulses. For example a gas discharge source may generate EUV radiation for a duration of approximately 10 to 100 nsec. A laser pulsed plasma may generate EUV for durations of approximately 5 to 50 nsec. The repetition rate for either source might be of the order of 10 kHz. In these situations, although the gas may be heated significantly by the EUV pulse, there is insufficient time for the gas to expand during the EUV pulse, so transmission conditions are essentially unaffected. If the heated gas can be cleared from the EUV path before the next pulse occurs, there will be no adverse effects of heating on the transmission. For example, if the speed of sound is 200 m/sec, and the EUV pulse lasts for 100 nsec, the volume of gas absorbing the radiation can only expand by the linear amount (200 m/sec)×100⁻⁹ sec=20 μm, which represent a very small fraction of the gas-volume dimensions.

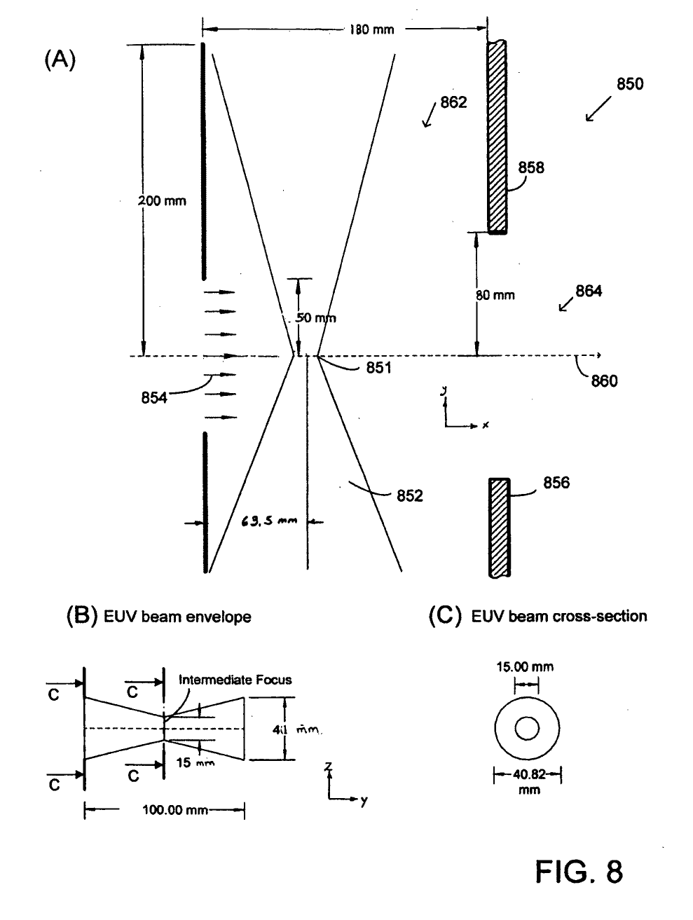

As an example, for the conditions described in FIG. 8(B), the gas has to move approximately 40 mm to completely clear the EUV envelope before the next pulse. For a pulse rate of 10 kHz, the clearing time is then 10⁻⁴ sec. This corresponds to a gas clearing velocity of v=0.04 m/10⁻⁴ sec=400 m/sec. For an ideal gas the speed of sound at temperature T is given by:

$$c = \sqrt{\frac{γ RT}{M}} , \qquad ( 4 )$$

where γ=cₚ/cᵥ is the ratio of the specific heat at constant pressure and volume of the gas, R=8.3145 J/K-mole is the gas constant, and M is the molar mass of the gas. If a mixture of gases is used, the molar mass is the weighted sum of the constituent gases' molar masses, as are the specific heats; γ for the mixture is the ratio of the mixture's specific heats. The Mach number of the gas is defined as v/c. At a gas temperature of 300 K, the speed of sound for Xe is 178 m/s. Thus, a clearing velocity of 400 m/sec corresponds to a Mach number of 2.25. A gas mixture with a lower molar weight than Xe would have a higher velocity of sound and a correspondingly smaller Mach number. For example, a 50:50 molar mixture of Ar and Xe would have a speed of sound of 220 m/sec, and the Mach number for the clearing velocity would be 1.82. The gas velocity is more relevant in determining the clearing time than the Mach number. However, supersonic nozzles are designed for the Mach number they produce with a gas, rather than the absolute gas velocity, which depends on temperature and gas composition, so it is useful in the present context. The gas velocity corresponding to the Mach number of a nozzle is determined by the gas conditions at the exhaust. If the nozzle exhausts into a low-density volume, the Mach number and gas velocity increase significantly as the distance from the exhaust increases.

For higher repetition rates, several pulses may occur during the clearing time. The situation then becomes similar to the case of a continuous source. The most favorable conditions for constant transmission remain a supersonic gas flow.

The gas-discharge nozzle can be a conventional converging-diverging nozzle such as shown in FIG. 1(A). In some examples, the nozzle is a so-called “aerospike” nozzle, while in other examples the nozzle is a “bell” nozzle. Desirably, the nozzle includes mechanisms configured to heat or cool the nozzle walls. Heating or cooling of the nozzle walls may be especially desirable when the gas discharge speed is greater than Mach 1. In general, heating or cooling of the nozzle walls can be useful for controlling properties of the discharged gas flow such as the temperature.

For example, by cooling the nozzle walls to maintain the nozzle wall temperature at a predetermined temperature (e.g., the temperature of the chamber or other region in which the nozzle is located) while gas is flowing out of the nozzle, the geometry of the resulting gas flow typically resembles isothermal gas flow. Furthermore, by heating the nozzle walls to a predetermined equilibrium state (e.g., the equilibrium state that results from heating thermally insulated walls of the nozzle by a constant flow of gas), the geometry of the resulting gas flow typically resemble isentropic gas flow. Either condition can produce a supersonic jet, but the gas conditions at the nozzle inlet are different. By adjusting the initial conditions appropriately, either heating condition, or an alternative heating or cooling condition can produce the desired supersonic jet. A small advantage for the isentropic flow condition, e.g., is the required inlet conditions can be estimated with reasonable accuracy from the desired exhaust conditions, using an analytic theory of one-dimensional isentropic flow. Such a theory can be found for example in Chapter 13 of Introduction to Fluid Mechanics by R. Fox and A. MacDonald.

Although the EUV transmission of a ND filter gas can be varied by adjusting the pressure of the discharged ND filter gas, such adjustments can also effect changes in the flow of the discharged stream of gas, which likewise affect the EUV transmission properties of the gaseous ND filter apparatus. For example, the discharge behavior of a typical bell nozzle depends on the difference between the exit pressure at the opening of the nozzle (e.g., the pressure outside the nozzle) and the pressure of the gas in a pressure chamber connected to the nozzle (e.g., the pressure of the gas before it exits the nozzle). Therefore, nozzle behavior, shock wave formation, the shape and geometry of the gas flow, the gas distribution, and the gas burden on the vacuum system can depend on the pressure of the ND filter gas. Such pressure-dependent variations in the gas flow can reduce the quality, accuracy and predictability of dose control in a gaseous ND filter system.

Accordingly, a nozzle having relatively low sensitivity to pressure changes, such as an aerospike nozzle, is desirable for some embodiments of a gaseous ND filter system. Properties of aerospike nozzles are described, e.g., at the website www.rocketdynetech.com/articles/nozzledesign.htm. For example, for embodiments of a gaseous ND filter in which the ND filter gas comprises a single attenuating gas (e.g., xenon gas), an aerospike nozzle is generally desirable to achieve predictable nozzle behavior that is relatively independent of the pressure of the ND filter gas relative to the exit pressure at the opening of the nozzle. However, for embodiments of a gaseous ND filter in which the ND filter gas comprises a mixture of gases (e.g., a mixture of xenon and argon gases), a constant total pressure of the mixture can be maintained, at least over a range of transmissions, so that nozzle sensitivity to pressure changes is either not of concern or of reduced concern. In these embodiments, either an aerospike or other conventional nozzle (e.g., bell nozzle) may be used.

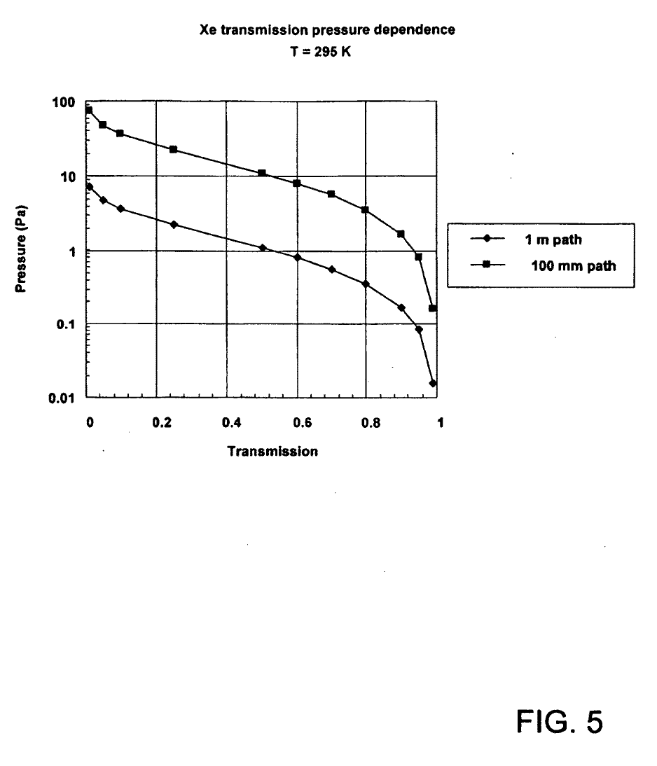

The length of the transmission path desirably is considered when determining the transmission properties of a gaseous ND filter system. For example, for the same gas conditions, transmission can be reduced by increasing the transmission path length. FIG. 5 is a plot of pressure versus EUV transmission for xenon gas at a temperature of 295 K for gaseous ND filters with a transmission path of 100 mm and with a transmission path of 1 m. As is evident from the plot, a selected level of transmission can be achieved using xenon gas of a reduced pressure when the transmission path is longer.

The gaseous ND filter apparatus 100 of FIG. 1(A) can be used or combined with other methods and apparatus for dose control and EUV beam attenuation. For example, the EUV beam 108 can be further attenuated in the illumination unit 112 such as by regulating the pressure, temperature, or both, of a gas filling the illumination unit, or by appropriate configuration of optics in the illumination unit. The gas filling the illumination unit 112 need not be the same gas as the gas used in the gaseous ND filter. Furthermore, one or more material ND filters downstream of the gaseous ND filter apparatus 100 (e.g., positioned among the illumination optics of the illumination unit) can be used in combination with the gaseous ND filter apparatus 100 to provide additional attenuation of the EUV beam such as for fine adjustment of an exposure dose.

In a particular implementation of a gaseous ND filter system in which the ND filter gas was xenon gas, an EUV beam having a 100 mm transmission path experienced 1% transmission through the stream of ND filter gas. The xenon gas pressure was 0.55 Torr (˜73 Pa) in the region intercepted by the EUV, the temperature of the gas was 300 K, and the mass flow of the xenon gas was 195 Torr−1/sec, as determined at the nozzle exhaust.

### Representative Embodiments

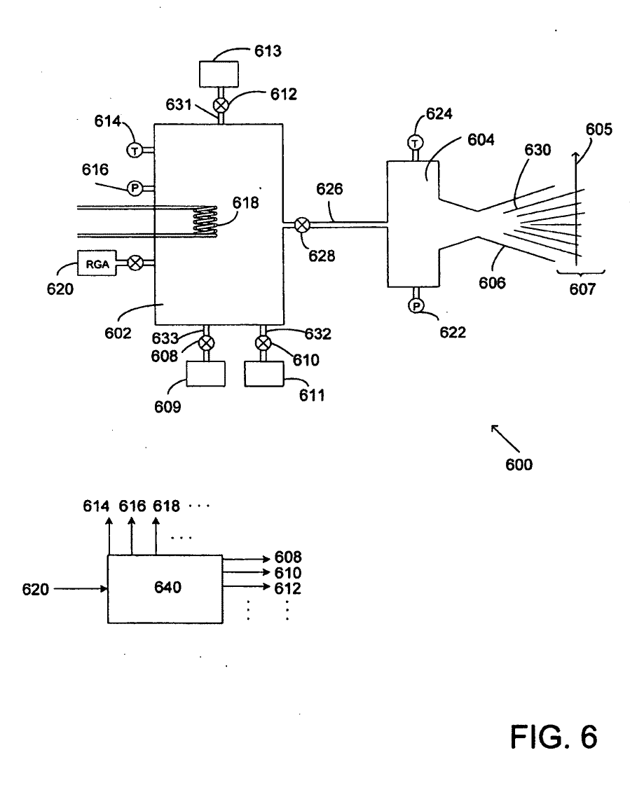

A first representative embodiment of a gas-discharge portion 600 of a gaseous ND filter apparatus is depicted in FIG. 6. The gas-discharge portion 600 comprises a mixing chamber 602 connected to a pressure chamber 604 via a conduit 626. One or more gases (e.g., attenuating gases, transmitting gases, or both) are supplied to the mixing chamber 602 from respective sources 609, 613 via gas-supply conduits 633 and 631. Supply from the sources 609, 613 to the mixing chamber 602 can be controlled by gas supply valves 608 and 612. A purge conduit 632 controlled by a valve 610 can be used to extract gas from the mixing chamber 602 into a chamber 611. Conduits such as conduit 626 are typically insulated to reduce temperature changes experienced by gases in the conduit. The conduits can also include heating mechanisms, cooling mechanisms or both.

The mixing chamber 602 is connected to various sensors and regulators configured to measure and adjust properties of the gas or gas mixture in the mixing chamber. For example, the mixing chamber 602 can be connected to a partial pressure analyzer. A partial pressure analyzer is a device or mechanism that is configured to measure and/or regulate the partial pressures of individual gases in the mixing chamber when the mixing chamber is used to contain a mixture of gases. A partial pressure analyzer can be used to determine the relative concentrations of the individual gases in the mixing chamber. Exemplary partial pressure analyzers are connected to or include residual gas analyzers and one or more mass flow analyzers. For example, the conduits 631, 633 can be connected to mass flow analyzers that measure the mass flow rate of gases from the sources 609, 613 into the mixing chamber 602. The mass flow analyzers can then be used to monitor and/or control (such as through communication with a controller 640) the amounts of gases released by valves 608, 612 from the sources 609, 613 into the mixing chamber 602. In this manner, the partial pressures of the individual gases can be monitored and regulated.

In this embodiment, the mixing chamber 602 is connected to a temperature sensor 614, a pressure sensor 616, and a residual gas analyzer 620. The residual gas analyzer 620 confirms the atomic or molecular composition of the gas mixture. Accurate mass flow sensors in principle could play the same role, but any in calibration could cause s in composition and transmission. The mixing chamber 602 can include a heater 618 and/or a cooling mechanism (not shown) for regulating gas temperature. A desired temperature and pressure for the gas contents of the mixing chamber 602 is achieved by using information from the sensors and analyzers to control the regulators and heaters connected to the mixing chamber 602.

In this embodiment, flow of gas between the mixing chamber 602 and the pressure chamber 604 is regulated by a valve 628. In some embodiments, the pressure chamber 604 is referred to as a “stagnation chamber” because the pressure chamber 604 provides stagnation conditions (including near or approximate stagnation) for a gas or gas mixture before release by a gas-discharge device (e.g., nozzle) 606. The stagnation conditions are the properties of the gas, such as temperature and pressure, when the flow velocity is zero. They are typically different from the conditions when the gas is flowing, as in the gas discharge device 606. The implicit assumption is that the volume of the chamber 604 is sufficiently large that stagnation conditions can exist despite the exhausting of the gas into the gas-discharge device 606. In some embodiments, a microchannel filter (not shown) separates the chamber 604 from the gas-discharge device 606. The filter can filter out particles originating from the gas supply, preventing them from entering the EUV vacuum chamber; and it can help to isolate the conditions in the chamber 604 from those in the gas-discharge device 606, thereby ensuring more uniform flow conditions at the entrance to the nozzle. The gas-discharge device 606 is configured to discharge the ND filter gas 630 as a stream of gas into an interaction region 607. Desirably, the gas-discharge device 606 is configured to discharge the filter gas 630 at a supersonic speed. The discharged stream of gas is positioned so as to interact with an EUV beam 605 passing through the interaction region 607. A gas-collection portion (not shown), which typically includes a pump (see FIG. 1(A)), can be situated to collect the discharged ND filter gas 630. The pressure chamber 604 can include a heater (not shown) and various gas sensors and regulators such as pressure sensor 622 and temperature sensor 624. The wall temperature of the nozzle may also be controlled.

The apparatus 600 can include a controller 640 for monitoring, controlling, and communicating with the sensors, regulators, analyzers, and heaters connected to the mixing chamber 602, the pressure chamber 604, or both. In this embodiment, the controller 640 receives input from the residual gas analyzer 620, and, based on the input, the controller 640 regulates the temperature and pressure of a gas or gas mixture in the mixing chamber 602. For example, the controller 640 controls the heater 618 and communicates with the sensors 614, 616, 622, 624. In this embodiment, the controller 640 also controls gas flow within the apparatus 600 and gas composition within the mixing chamber 602 regulating valves 608, 610, 612, 628.

In some embodiments, the pressure chamber 604 can function as a mixing chamber such that a separate mixing chamber 602 is not needed. For example, the pressure chamber 604 can be configured to receive gases through one or more gas-supply conduits, and the pressure and temperature of the received gases can be regulated in the pressure chamber. Such a pressure chamber can include a valve or dividing wall between the gas-discharge device and the region of the chamber where the gases are mixed to facilitate stagnation of the gases. When tight control of the gaseous ND filter transmission properties is required, a separate mixing chamber 602 and pressure chamber 604 is advantageous.

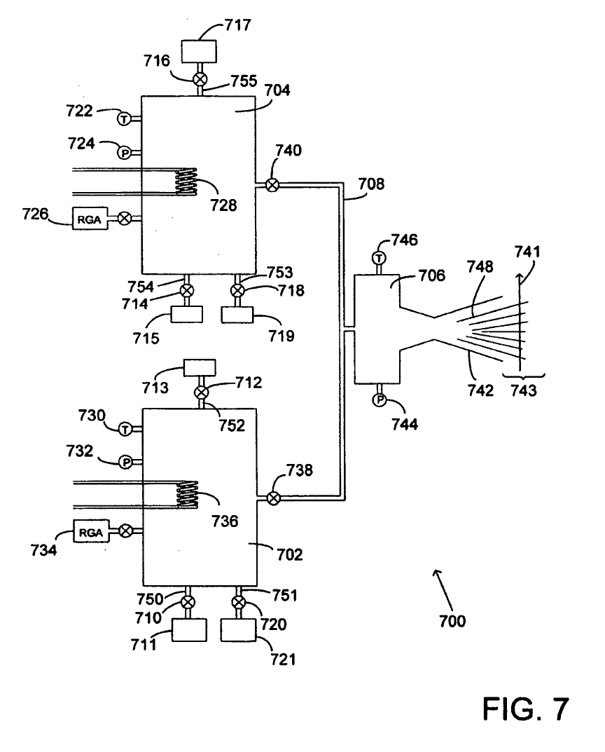

A second representative embodiment of a gas-discharge portion 700 of a gaseous ND filter apparatus is depicted in FIG. 7. The gas-discharge portion 700 comprises first and second mixing chambers 702, 704 connected to a pressure chamber 706 via a conduit 708. One or more gases (e.g., attenuating gases, transmitting gases, or both) are supplied to the mixing chambers 702, 704 from sources 711, 713, 715, 717 through respective gas-supply conduits 750, 752, 754, 755. Supply from the sources 711, 713, 715, 717 to the mixing chambers 702, 704 can be controlled by respective gas supply valves 710, 712, 714, 716. Purge conduits 753, 751 controlled by respective purge values 718, 720 can be used to extract gas from the respective mixing chambers 704, 702 into respective purge chambers 719, 721. Conduits such as the conduit 708 are desirably insulated to reduce temperature changes that otherwise could be experienced by gases in the conduit. The conduits can also include heating mechanisms, cooling mechanisms or both, or otherwise be configured for temperature control of gases.

The mixing chambers 702, 704 comprise various sensors and regulators for measuring and adjusting properties of the gas or gas mixture in the mixing chambers 702, 704. For example, the mixing chambers 702, 704 can be connected to one or more partial pressure analyzers (see discussion related to FIG. 6). In this embodiment, the mixing chambers 702, 704 are connected to temperature sensors 722, 730, pressure sensors 724, 732 and residual gas analyzers 726, 734. With the addition of a manifold, valves and a purge means, a single residual gas analyzer could be shared between the chambers 702 and 704. The mixing chambers 702, 704 can include respective heaters 728, 736 and cooling mechanisms (not shown) for regulating gas temperature. Desired temperatures and pressures for the gas contents of the mixing chambers 702, 704 are achieved by using information from the sensors and analyzers to control the regulators and heaters connected to the mixing chambers 702, 704.

In this embodiment, flow of gas between the mixing chambers 702, 704 and the pressure chamber 706 is regulated by valves 738, 740. In some embodiments, the pressure chamber 706 is referred to as a “stagnation chamber” because the pressure chamber 706 provides stagnation conditions (including near or approximate stagnation) for a gas or gas mixture before release by gas-discharge device (e.g., nozzle) 742. The gas-discharge device 742 is configured to discharge the ND filter gas 748 as a stream into an interaction region 743. The interaction region 743 can be contained within an interaction chamber (not shown). Desirably, the gas-discharge device 742 is configured to discharge the gas 748 at a supersonic speed. The discharged stream of gas is positioned so as to interact with an EUV beam 741 passing through the interaction region 743. A gas-collection portion (not shown), which typically includes a pump (see FIG. 1(A)), can be situated to collect the discharged ND filter gas 748. The pressure chamber 706 can include a heater (not shown, but see FIG. 6) and various gas sensors and regulators such as pressure sensor 744 and temperature sensor 746. The apparatus 700 can include a controller (not shown) for monitoring and controlling sensors, regulators, analyzers, and heaters connected to the mixing chambers 702, 704, the pressure chamber 706, or both. Such a controller can regulate gas discharge and the temperature and pressure of a gas or gas mixture in the mixing chambers 702, 704.

In general, a gaseous ND filter apparatus having two mixing chambers such as the apparatus 700 may be advantageous when multiple exposure dose conditions are needed. For example, for the gas-discharge portion 700, a first dose is prepared by mixing a first and a second gas in the mixing chamber 702, heating and pressurizing the mixture appropriately to achieve selected transmission properties, and opening the valve 738 to release the mixture into the pressure chamber 706. Alternatively, a single gas is pressurized and heated appropriately in the first mixing chamber 702 before being released to the pressure chamber 706. The gas or mixture of gases from the first mixing chamber 702 is then discharged from the pressure chamber 706 as a stream of gas providing the selected transmission to an EUV beam 741 in the interaction region 743.

While the valve 740 is closed, a second dose is prepared in the second mixing chamber 704. The gas or mixture of gases in the second mixing chamber 704 can be prepared with different transmission properties than the gas content of the first mixing chamber 702. For example, the contents of the second mixing chamber 704 can be prepared to have a different temperature, pressure, or relative gas concentration than the contents of the first mixing chamber 702. In order to provide the second dose, the valve 738 is closed and the valve 740 is opened to allow the contents of the second mixing chamber 704 to enter the pressure chamber 706. The gas or mixture of gases from the second mixing chamber 704 is then discharged from the pressure chamber 706 into the interaction region 743, the discharged stream of gas having different transmission properties from the first dose.

Therefore, a gaseous ND filter system including two or more mixing chambers is desirable for making relatively quick changes to the transmission properties of the gaseous ND filter such as by allowing two or more exposure doses to be simultaneously available.

In representative embodiments of a gaseous ND filter, such as those described above, the interaction region can be situated within an interaction chamber. An EUV beam generated by an EUV source interacts with the ND filter gas within the interaction chamber positioned downstream from the EUV source and upstream from illumination optics. A first representative embodiment of an interaction chamber 850 is depicted in FIG. 8(A). A transverse profile and a cross-sectional view of an exemplary EUV beam are depicted in FIGS. 8(B) and 8(C), respectively. The section of the envelope of the EUV beam depicted in FIG. 8(B) represents the portion of the EUV beam that interacts with the ND filter gas 854 in the chamber 850. In the chamber 850, the stream of the ND filter gas 854 emerges from a nozzle 100 mm wide, and the intermediate focus of the EUV beam is positioned at the center of the stream of gas. The dimension of the nozzle in the z direction (not shown) is 50 mm. Walls (not shown) parallel to the x-y plane and located on the z axis at or beyond the opening of the nozzle may be included, to limit diffusion of the gas in the z direction. FIG. 8(C) provides a cross-sectional view of the EUV beam depicted in FIG. 8(B) at lines C-C. As indicated in FIG. 8(C), the distance 15 mm is the diameter of the EUV beam at the intermediate focus, and the distance 41 mm is the approximate diameter of the EUV beam at an edge of the stream of the ND filter gas 854.

By way of example, dimensions of the chamber 850 and of the EUV beam are indicated in FIGS. 8(A)-8(C). However, the dimensions are merely exemplary and need not be limited to those depicted in FIGS. 8(A)-8(C). For example, in a system that receives an EUV beam having a diameter larger than the beam diameter indicated in FIGS. 8(B) and 8(C), a larger interaction chamber may be desirable.

The interaction chamber 850 comprises chamber walls 856, 858 and receives a stream of ND filter gas 854 and an EUV beam 852. The stream of ND filter gas 854 can be received from a gas-discharge portion such as described above. The EUV beam 852 is generally received from an upstream EUV source and transmitted to a downstream illumination unit after traversing the interaction chamber 850. In the embodiment, the interaction chamber 850 is positioned such that the intermediate focus 851 of the EUV beam 852 is positioned at an approximate center of the gas stream 854, as indicated by an axis 860. Typically, regions 862, 864 are maintained at vacuum or very low pressure. In the embodiment, the chamber 850 is symmetric across the axis 860.

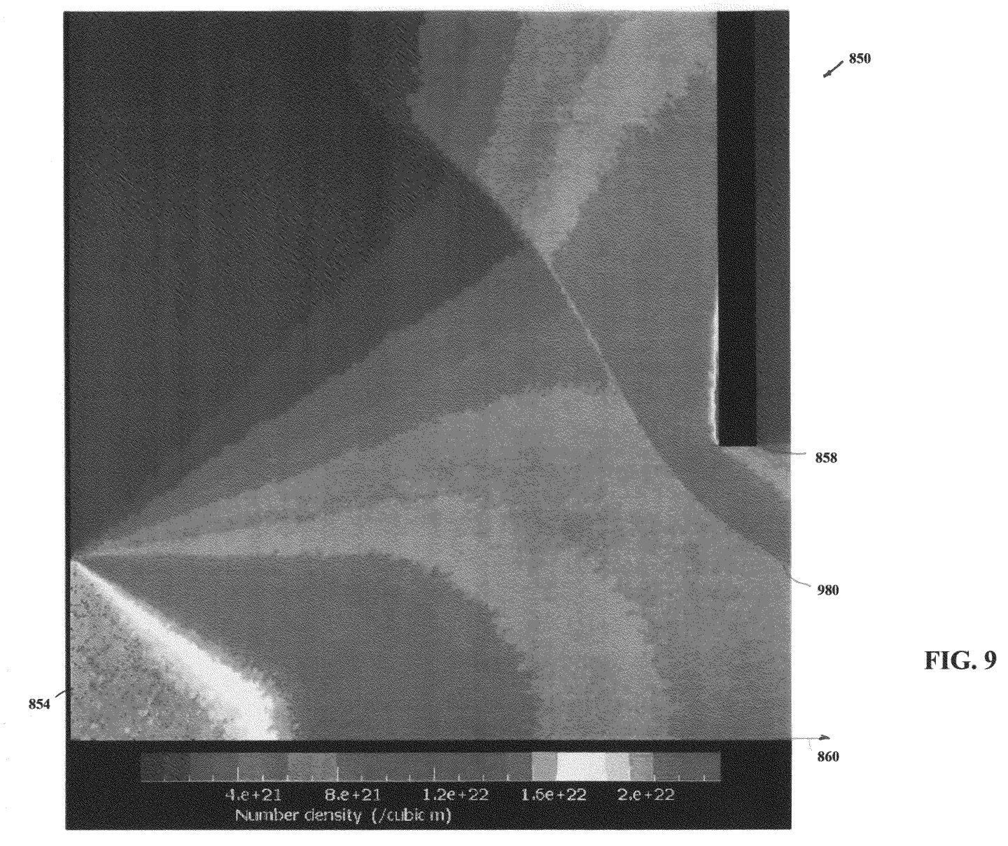

FIG. 9 is a density graph of gas in the top half of the interaction chamber 850, based on a two dimensional DSMC simulation. In this simulation Xe gas emerges from the nozzle at a density of approximately 2.0×10²² m⁻³, velocity in the x-direction of 250 m/sec and a temperature of 300 K. The average density along the center of the EUV beam is approximately 4.5×10²¹ m⁻³, and the EUV transmission is approximately 0.0104. The graph illustrates that the ND filter gas 854 discharged from the gas-discharge portion into the interaction chamber 850 forms a gas stream and a shock wave 980 in the chamber. The shock wave 980 is shown at an interior portion of the chamber wall 858 and extends toward the center of the interaction chamber 850. In a typical implementation, an EUV beam (see FIG. 8(A)) traverses the gas stream and is attenuated. Depending on the width of the EUV beam, a portion of the EUV beam may interact with the shock wave causing non-uniform attenuation across the beam. Therefore, it is advantageous to have the position of the EUV beam and of the shock wave be such that the EUV beam does not intercept the shock wave. Gas flowing into the region 864 is collected by a pump and removed from the EUV vacuum system. In this simulation about 71% of the gas from the nozzle is removed in this way. The rest escapes into the EUV vacuum system, where it must be removed by the EUV system's vacuum pumps.

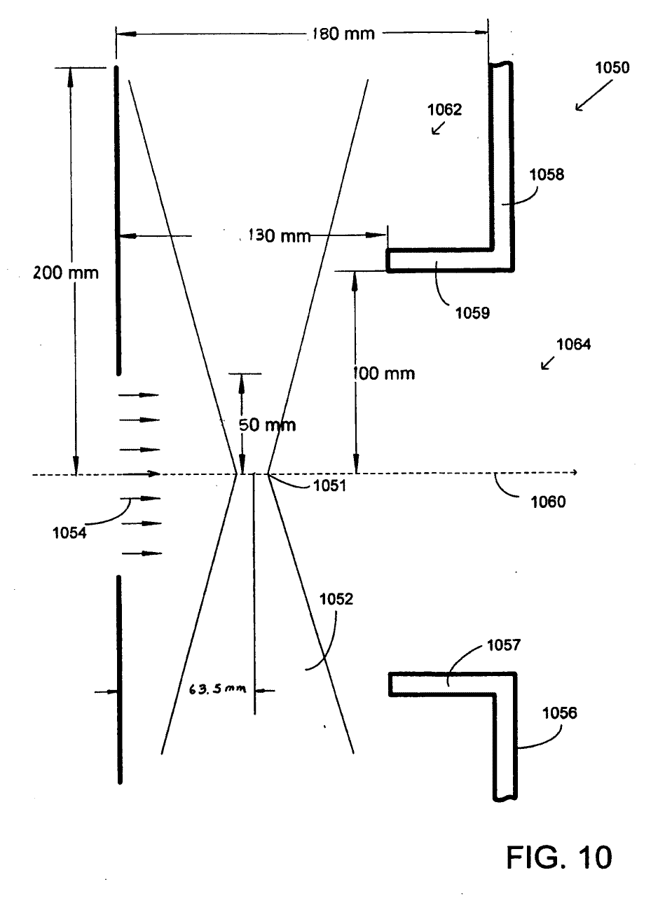

A second representative embodiment of an interaction chamber 1050 is depicted in FIG. 10. By way of example, dimensions of the chamber 1050 are indicated in FIG. 10. However, the dimensions of the chamber 1050 need not be limited to those depicted in FIG. 10. The interaction chamber 1050 comprises chamber walls 1056, 1057, 1058, 1059 and receives a stream of ND filter gas 1054 and an EUV beam 1052. The stream of ND filter gas 1054 can be received from a gaseous ND filter apparatus such as described above. The EUV beam 1052 is generally received from an upstream EUV source and transmitted to a downstream illumination unit after traversing the interaction chamber 1050. In the embodiment, the interaction chamber 1050 is positioned such that the intermediate focus 1051 of the EUV beam 1052 is within the stream of ND filter gas 1054. Preferably, the intermediate focus of the EUV beam 1052 is positioned at an approximate center of the gas stream 1054, as indicated by an axis 1060. Typically, the regions 1062, 1064 are maintained at vacuum or at very low pressure. In the embodiment, the chamber 1050 is substantially symmetric across an axis 1060.

Although representative embodiments of interaction chambers described herein are symmetric across an axis defined along the center of the gas stream, interaction chambers need not be symmetric. For example, an asymmetric interaction chamber may be desirable when the generated flow of gas is asymmetric or in order to direct the flow of gas away from a downstream illumination unit.

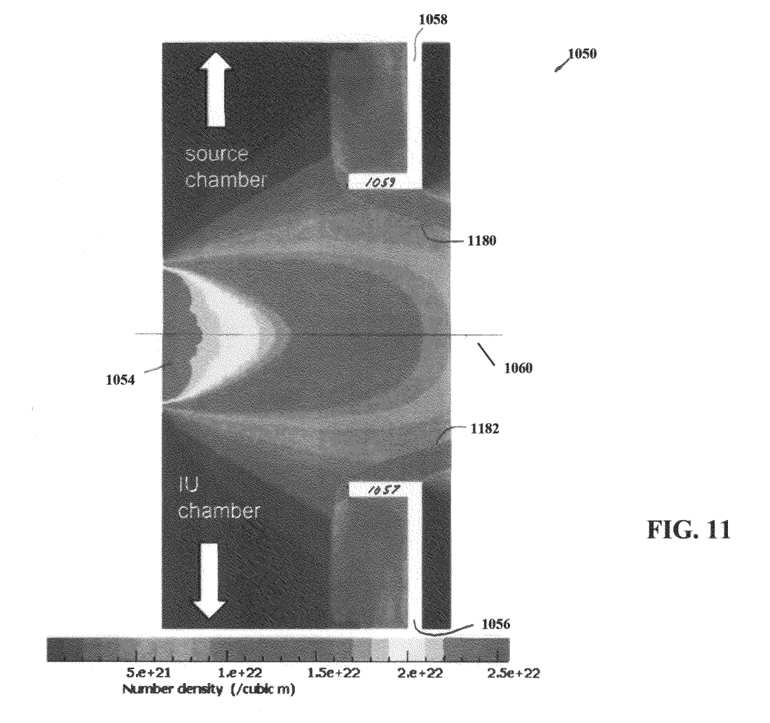

FIG. 11 is a density graph of gas discharged into the chamber 1050, based on a two-dimensional DSMC simulation. In this simulation Xe gas emerges from the nozzle at a density of approximately 2.3×10²² m⁻³, velocity in the x-direction of 349 m/sec and a temperature of 322 K. The average density along the center of the EUV beam is approximately 5.4×10²¹ m⁻³, and the EUV transmission is approximately 0.004. The graph illustrates that the ND filter gas 1054 discharged into the interaction chamber 1050 forms a gas stream and shock waves 1180, 1182. When compared to the shock wave 980 shown in FIG. 9, the chamber walls 1059, 1057 in FIG. 11 produce a narrower shock wave having a boundary that runs approximately parallel to a direction of propagation of an EUV beam from a source chamber to an IU chamber. Therefore, any interaction between the EUV beam and shock waves 1180, 1182 in chamber 1050 of FIG. 11 is substantially reduced relative to any interaction between the EUV beam and the shock wave 980 in chamber 850 of FIG. 9. Preferably, the respective sizes of the EUV beam and of the shock wave are such that the EUV beam interaction with the shock wave are minimized or reduced. Gas flowing into the region 1064 is collected by a pump and removed from the EUV vacuum system. In this simulation about 90% of the gas from the nozzle is removed in this way. The rest escapes into the EUV vacuum system, where it must be removed by the EUV system's vacuum pumps.

Accordingly, an interaction chamber such as chamber 1050 may be advantageous over a chamber such as chamber 850 because in the chamber 1050, interaction is between the EUV beam and shock waves can be reduced or eliminated. The chamber 1050 may also be desirable because of the high gas collection efficiency that can be achieved when an exhaust pump is used in the region 1064.

Because shock-wave formation depends at least partially on the chamber structure, chamber walls can be designed such that adverse effects from shock wave interaction with the EUV beam are reduced. For example, if gas-flow properties (e.g., gas content, pressure, geometry, etc.) are known, shock-wave formation can be simulated and the chamber walls designed accordingly. Therefore, embodiments of a gaseous ND filter in which the gas-flow properties are relatively independent of gas pressure are desirable because a chamber structure can be designed that effectively reduces the interaction between the EUV beam and the shock wave over a range of transmission levels. Such embodiments include gaseous ND filters in which the ND filter gas is a mixture of gases and a total pressure is maintained, and gaseous ND filters in which the ND filter gas comprises a single gas that is discharged by an aerospike nozzle.

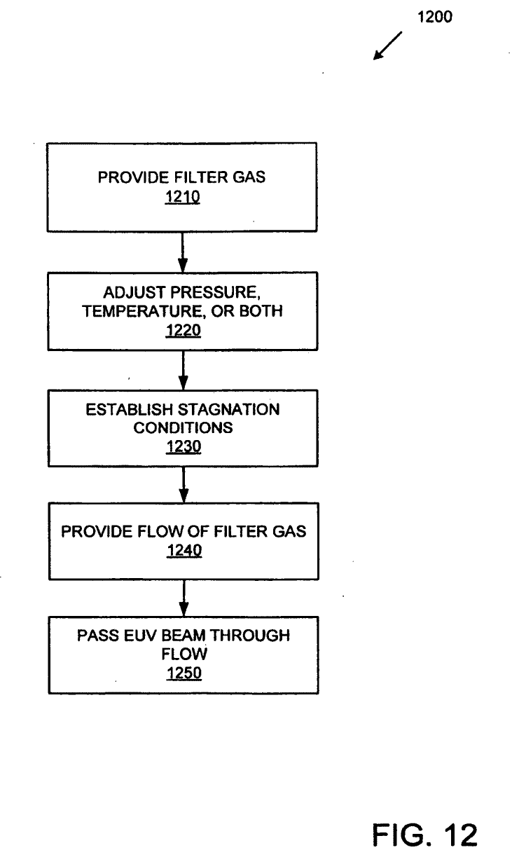

An EUV beam can be attenuated with a stream of gas through processes performed using gaseous ND filter systems as described above. FIG. 12 is a flow-chart of an exemplary method 1200 for attenuating an EUV beam with a supersonic flow of gas. At 1210, a filter gas comprising a gas that is attenuating of EUV radiation is provided. The filter gas can comprise a single gas (e.g., xenon) or the filter gas can be a mixture of gases. For a filter gas that is a mixture of gases, the providing of the filter gas can include mixing two or more gases (e.g., xenon and argon) such as in a mixing chamber. At 1220, the pressure, temperature, or both, of the filter gas is adjusted. For a filter gas that is a mixture of gases, the pressure of each of the gases in the mixture can be adjusted to maintain a constant total pressure while changing the relative pressure difference between the gases. Adjusting of the filter gas pressure or temperature can include measuring or sensing such properties, or determining a mixture composition such as with a residual gas analyzer. At 1230, the filter gas is allowed to attain stagnation conditions. For example, the mixture can be injected into a stagnation chamber connected to a nozzle. At 1240, the filter gas is discharged as a stream of gas. Desirably, the filter gas is discharged at a supersonic speed. At 1250, an EUV beam is passed through the stream of gas so as to attenuate one or more frequencies of the EUV beam. Passing of the EUV beam through stream of filter gas can include generating the EUV beam and directing it toward the stream of gas. The method 1200 can be repeated as needed to change the transmission properties of the stream of filter gas. The exemplary method 1200 can be performed using a gaseous ND filter apparatus as described herein.

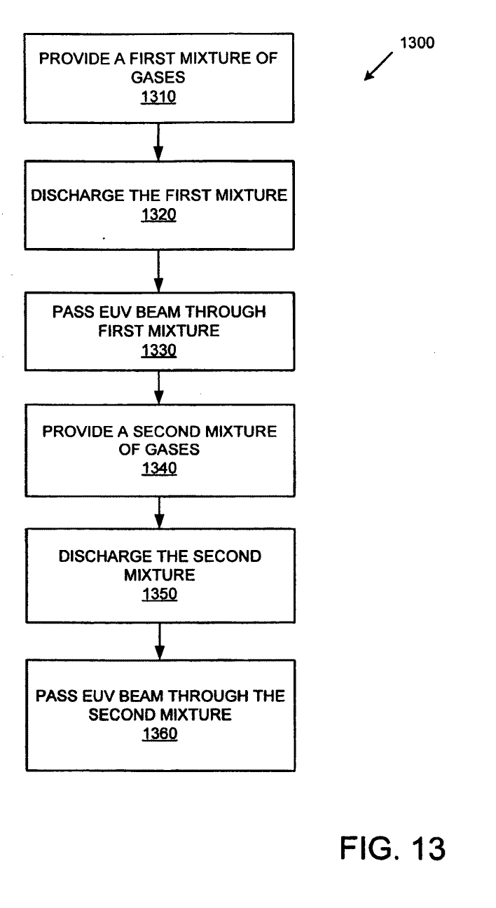

FIG. 13 is a flow-chart of an exemplary method 1300 for attenuating an EUV beam using a discharged mixture of gases. At 1310, a first mixture of gases having a selected total pressure is provided. The first mixture of gases is generated by mixing at least one attenuating gas and at least one transmitting gas, wherein each gas is characterized by a respective initial partial pressure. For example, predetermined amounts of an attenuating gas and a transmitting gas can be injected into a mixing chamber such that the selected total pressure for the mixture and the respective initial partial pressures are achieved. Providing the mixture can also include sensing and adjusting the pressure, temperature, or concentration of the attenuating and the transmitting gases. At 1320, the first gas mixture is discharged as a stream of gas. The first mixture can be discharged at a supersonic speed. At 1330, an EUV beam of a first intensity is passed through the stream of the first gas mixture. In interacting with the stream of gas, one or more frequencies of the EUV beam are attenuated, thereby generating a first attenuated EUV beam having an intensity that is less than the first intensity.

At 1340, a second mixture of gases having substantially the same selected total pressure as the first mixture of gases is provided. The second mixture of gases is also generated by mixing the at least one attenuating and at least one transmitting gases; however, in the second mixture, each gas is characterized by a partial pressure that is different from their respective initial partial pressures. For example, the second mixture of gases can include a higher or lower concentration of the attenuating gas relative to the first mixture. At 1350, the second mixture of gases is discharged as a stream of gas. The second mixture can be discharged at a supersonic speed. At 1360, an EUV beam having an intensity substantially the same as the first intensity passes through the stream of the second mixture of gases. In interacting with the stream of gas, one or more frequencies of the EUV beam are attenuated, thereby generating a second attenuated EUV beam having an intensity that is different from the intensity of the first attenuated EUV beam. The exemplary method 1300 can be performed using any of various gaseous ND filter apparatus described herein.

### Demonstration of Gaseous ND Filter as an Effective Gas Curtain

Gaseous ND filters as described herein can also be effectively employed as a gas curtain to prevent contaminants such as those generated by an upstream EUV source from entering a downstream illumination unit. Positioned between the EUV source chamber and the illumination unit, the stream of ND filter gas can serve as a physical barrier that at least slows down the rate at which debris and/or gas from the EUV source migrate to the illumination unit and beyond. Thus, the gaseous ND filter can prevent at least some of the debris and/or gas from an EUV source from contaminating, degrading, or otherwise damaging downstream optics such as the optical elements of the illumination unit.

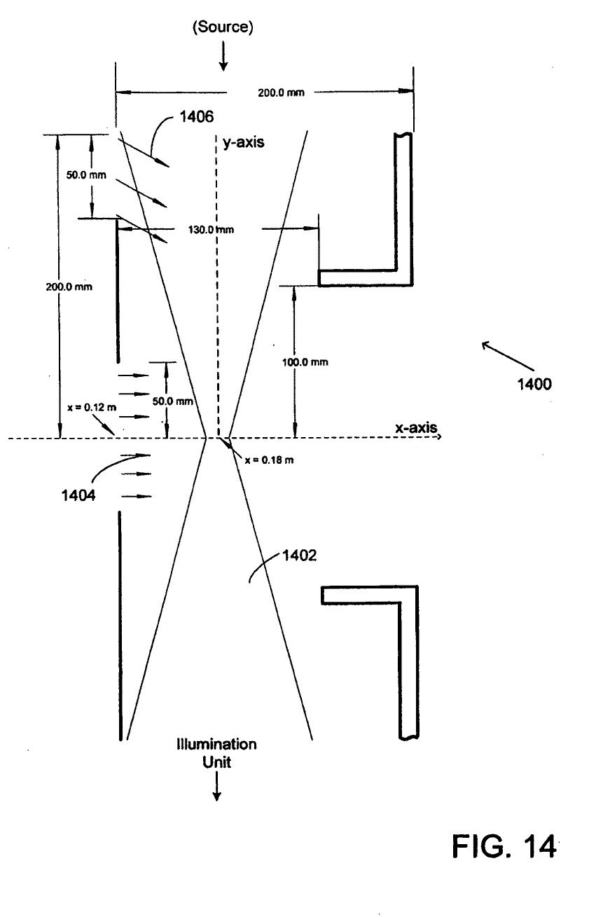

The effectiveness of a gaseous ND filter as a gas curtain was verified through numerical modeling. The model simulated gas flow in an interaction chamber 1400 as shown in FIG. 14. The interaction chamber 1400 is configured to receive an EUV beam 1402, a ND filter gas stream 1404, and a contaminant gas 1406. The contaminant gas 1406 represents contaminants such as those generated by an EUV source. For example, krypton gas was used as the contaminant gas while modeling contaminants associated with a typical Sn EUV source and helium gas was used as the contaminant gas while modeling contaminants generated by a typical lithium EUV source.

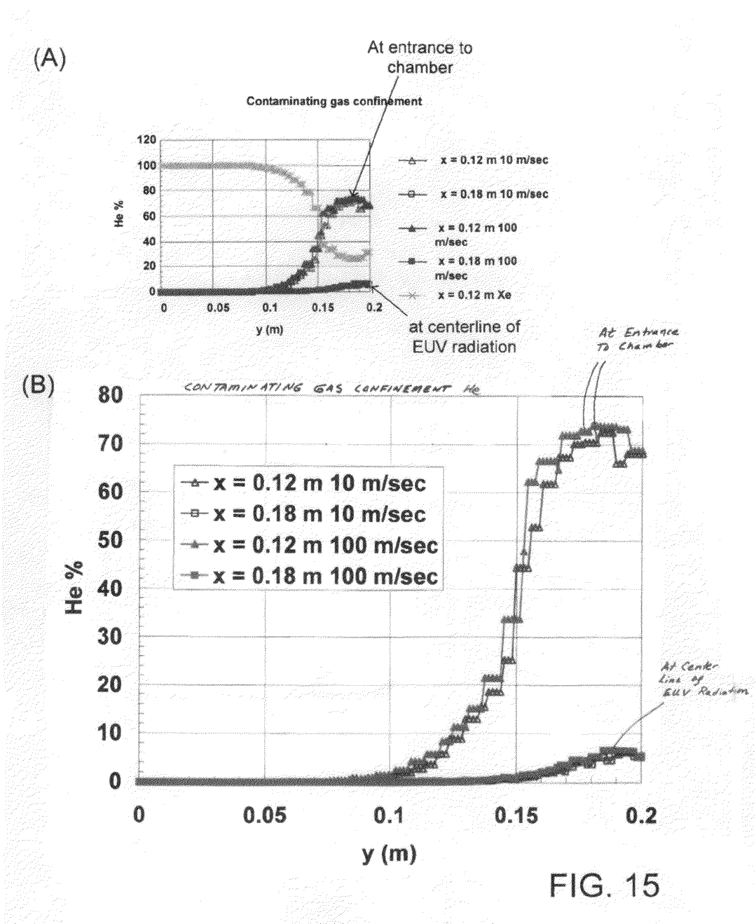

In the model, a contaminant gas 1406 having a density of 10²⁰ m⁻³ entered the interaction chamber 1400 at a 45-degree angle as shown in FIG. 14. The ND filter gas stream 1404 had a density of 2×10²² m⁻³. FIGS. 15(A) and 15(B) demonstrate the effectiveness of the Xe ND filter gas stream 1404 at confining the contaminant gases of helium and krypton, respectively.

FIGS. 15(A) and 15(B) show gas concentration as a function of y position wherein the y-axis is along a centerline of the EUV beam and y=0 at the intermediate focus of the EUV beam (see FIG. 14). The contaminant gas concentration is plotted at x=0.12 m and at x=0.18 m for two different contaminant gas velocities. The x-position is measured along the x-axis, defined as the centerline of the ND filter gas stream, wherein x=0.12 m is at the opening of the chamber entrance and x=0.18 m at the centerline of the EUV beam (see FIG. 14). FIGS. 15(A) and 15(B) demonstrate that a stream of ND filter gas in a gaseous ND filter can function to reduce contaminant gas from traversing the ND filter gas stream and entering downstream optics.

### EUVL Systems

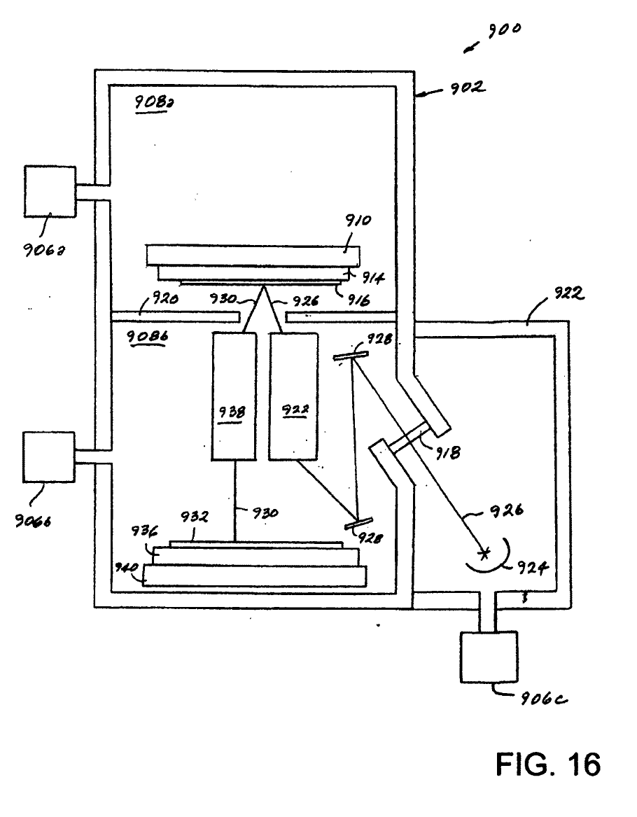

Referring now to FIG. 16, an embodiment of an EUVL system 900 is shown. The depicted system 900 comprises a vacuum chamber 902 including vacuum pumps 906a, 906b that are arranged to enable desired vacuum levels to be established and maintained within respective chambers 908a, 908b of the vacuum chamber 902. For example, the vacuum pump 906a maintains a vacuum level of approximately 50 mTorr in the upper chamber (reticle chamber) 908a, and the vacuum pump 906b maintains a vacuum level of less than approximately 1 mTorr in the lower chamber (optical chamber) 908b. The two chambers 908a, 908b are separated from each other by a barrier wall 920. Various components of the EUVL system 900 are not shown, for ease of discussion, although it will be appreciated that the EUVL system 900 can include components such as a reaction frame, a vibration-isolation mechanism, various actuators, and various controllers.

An EUV reticle 916 is held by a reticle chuck 914 coupled to a reticle stage 910. The reticle stage 910 holds the reticle 916 and allows the reticle to be moved laterally in a scanning manner, for example, during use of the reticle for making lithographic exposures. An illumination source 924 is contained in a vacuum chamber 922 evacuated by a vacuum pump 906c. The illumination source 924 produces an EUV illumination beam 926 that is transmitted through a gaseous ND filter 918, as described above, and enters the optical chamber 908b. The illumination beam 926 reflects from one or more mirrors 928 and through an illumination-optical system 922 to illuminate a desired location on the reticle 916. As the illumination beam 926 reflects from the reticle 916, the beam is “patterned” by the pattern portion actually being illuminated on the reticle. The barrier wall 920 defines an aperture 934 through which the illumination beam 926 illuminates the desired region of the reticle 916. The incident illumination beam 926 on the reticle 916 becomes patterned by interaction with pattern-defining elements on the reticle. The resulting patterned beam 930 propagates generally downward through a projection-optical system 938 onto the surface of a wafer 932 held by a wafer chuck 936 on a wafer stage 940 that performs scanning motions of the wafer during exposure. Hence, images of the reticle pattern are projected onto the wafer 932.

The wafer stage 940 can include (not detailed) a positioning stage that may be driven by a planar motor or one or more linear motors, for example, and a wafer table that is magnetically coupled to the positioning stage using an EI-core actuator, for example. The wafer chuck 936 is coupled to the wafer table, and may be levitated relative to the wafer table by one or more voice-coil motors, for example. If the positioning stage is driven by a planar motor, the planar motor typically utilizes respective electromagnetic forces generated by magnets and corresponding armature coils arranged in two dimensions. The positioning stage is configured to move in multiple degrees of freedom of motion, e.g., three to six degrees of freedom, to allow the wafer 932 to be positioned at a desired position and orientation relative to the projection-optical system 938 and the reticle 916.

Movements of the wafer stage 940 and the reticle stage 910 generate reaction forces that may adversely affect performance of the EUVL system 900. Reaction forces generated by motion of the wafer stage 940 may be released mechanically to the floor or ground via a frame member, as discussed in U.S. Pat. No. 5,528,118 and in Japan Kôkai Patent Document No. 8-166475. Reaction forces generated by motions of the reticle stage 910 may be mechanically released to the floor or ground by use of a frame member as described in U.S. Pat. No. 5,874,820 and Japan Kôkai Patent Document No. 8-330224, all of which being incorporated herein by reference in their respective entireties.

An EUVL system including the above described EUV-source and illumination-optical system can be constructed by assembling various assemblies and subsystems in a manner ensuring that prescribed standards of mechanical accuracy, electrical accuracy, and optical accuracy are met and maintained. To establish these standards before, during, and after assembly, various subsystems (especially the illumination-optical system and projection-optical system) are assessed and adjusted as required to achieve the specified accuracy standards. Similar assessments and adjustments are performed as required of the mechanical and electrical subsystems and assemblies. Assembly of the various subsystems and assemblies includes the creation of optical and mechanical interfaces, electrical interconnections, and plumbing interconnections as required between assemblies and subsystems. After assembling the EUVL system, further assessments, calibrations, and adjustments are made as required to ensure attainment of specified system accuracy and precision of operation. To maintain certain standards of cleanliness and avoidance of contamination, the EUVL system (as well as certain subsystems and assemblies of the system) are assembled in a clean room or the like in which particulate contamination, temperature, and humidity are controlled.

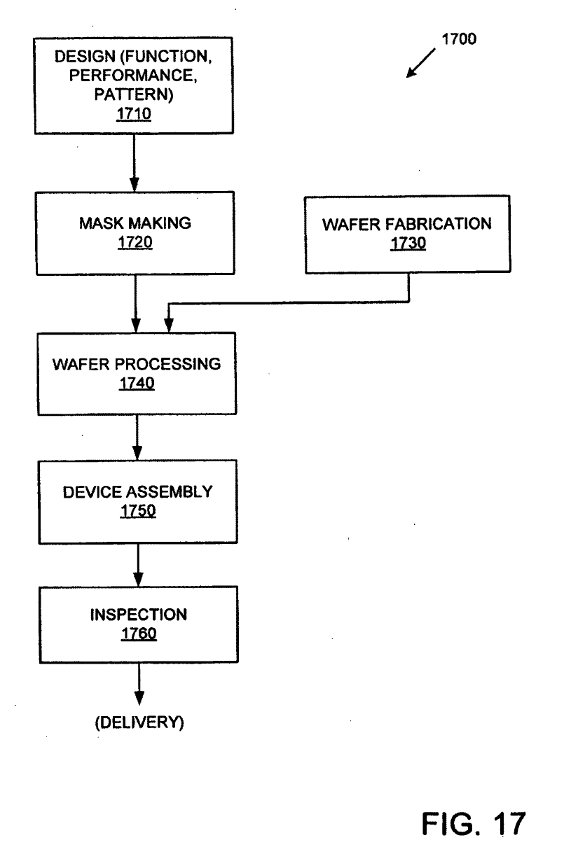

Semiconductor devices can be fabricated by processes including microlithography steps performed using a microlithography system as described above. Referring to FIG. 17, in step 1710 the function and performance characteristics of the semiconductor device are designed. In step 1720 a reticle defining the desired pattern is designed according to the previous design step. Meanwhile, in step 1730, a substrate (wafer) is made and coated with a suitable resist. In step 1740 the reticle pattern designed in step 1720 is exposed onto the surface of the substrate using the microlithography system. In step 1750 the semiconductor device is assembled (including “dicing” by which individual devices or “chips” are cut from the wafer, “bonding” by which wires are bonded to the particular locations on the chips, and “packaging” by which the devices are enclosed in appropriate packages for use). In step 1760 the assembled devices are tested and inspected.

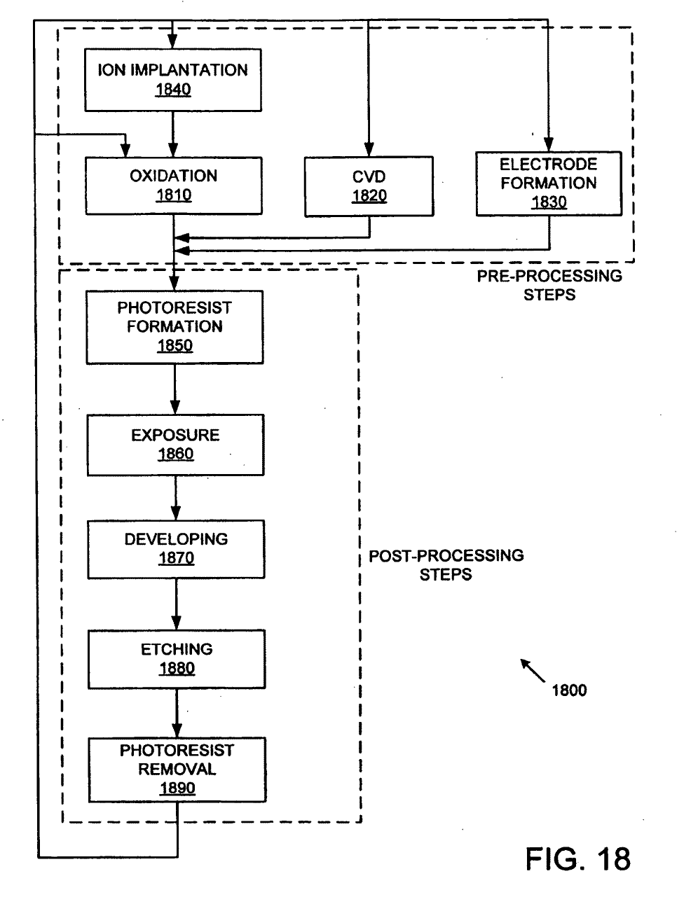

Representative details of a wafer-processing process including a microlithography step are shown in FIG. 18. In step 1810 (oxidation) the wafer surface is oxidized. In step 1820 (CVD) an insulative layer is formed on the wafer surface. In step 1830 (electrode formation) electrodes are formed on the wafer surface by vapor deposition for example. In step 1840 (ion implantation) ions are implanted in the wafer surface. These steps 1810-1840 constitute representative “pre-processing” steps for wafers, and selections are made at each step according to processing requirements.

At each stage of wafer processing, when the pre-processing steps have been completed, the following “post-processing” steps are implemented. A first post-process step is step 1850 (photoresist formation) in which a suitable resist is applied to the surface of the wafer. Next, in step 1860 (exposure), the microlithography system described above is used for lithographically transferring a pattern from the reticle to the resist layer on the wafer. In step 1870 (development) the exposed resist on the wafer is developed to form a usable mask pattern, corresponding to the resist pattern, in the resist on the wafer. In step 1880 (etching), regions not covered by developed resist (i.e., exposed material surfaces) are etched away to a controlled depth. In step 1890 (photoresist removal), residual developed resist is removed (“stripped”) from the wafer.

Formation of multiple interconnected layers of circuit patterns on the wafer is achieved by repeating the pre-processing and post-processing steps as required. Generally, a set of pre-processing and post-processing steps are conducted to form each layer.

It will be apparent to persons of ordinary skill in the relevant art that various modifications and variations can be made in the system configurations described above, in materials, and in construction without departing from the spirit and scope of this disclosure.

What is claimed is:

1. A device for attenuating a beam of electromagnetic radiation, comprising:
a gas-discharge portion pneumatically coupled to a source of a filter gas comprising a first attenuating gas that attenuates at least one wavelength of the electromagnetic radiation, the gas-discharge portion being configured to produce a stream of the filter gas; and
a gas-radiation interaction portion coupled to the gas-discharge portion to receive the stream of the filter gas, the stream of filter gas propagating in a direction such that the beam traverses the stream in the interaction portion and is attenuated by the stream as the beam passes through the stream.

2. The device of claim 1, wherein the gas-discharge portion comprises a nozzle directed to discharge the filter gas into the interaction portion.

3. The device of claim 2, wherein the nozzle is configured to produce the stream of filter gas flowing at a supersonic velocity through the interaction portion.

4. The device of claim 3, wherein the nozzle is configured as a bell nozzle or an aerospike nozzle.

5. The device of claim 1, wherein:
the gas-discharge portion comprises a nozzle directed to discharge the filter gas into the interaction portion;
the nozzle is configured to produce the stream of filter gas flowing at a supersonic velocity through the interaction portion; and
the nozzle includes a nozzle-wall temperature-control device to maintain the wall within a preselected temperature range.

6. The device of claim 1, wherein:
the beam propagates along a first axis; and
the stream of filter gas propagates through the interaction portion along a second axis perpendicular to the first axis.

7. The device of claim 1, wherein the gas-discharge portion produces the stream of filter gas dimensioned such that substantially all the beam passes through the stream in the interaction portion.

8. The device of claim 1, wherein the filter gas comprises a mixture of the first attenuating gas and at least a second attenuating gas.

9. The device of claim 1, wherein the filter gas comprises a mixture of the first attenuating gas and at least one transmitting gas.

10. The device of claim 9, further comprising a gas-source portion pneumatically coupled to the gas-discharge portion, the gas-source portion comprising a respective pressure-adjustable source of each of the gases in the filter gas.

11. The device of claim 1, wherein the gas-discharge portion further comprises:
a mixing chamber in which a mixture of the filter gas is prepared; and
a pressure chamber coupled downstream of the mixing chamber to establish a pressure condition of the filter gas for producing the stream.

12. The device of claim 11, wherein:
the filter gas comprises at least the first gas and a second gas;
the mixing chamber comprises a partial pressure analyzer sensitive at least to the first and second gases and operable to determine respective partial pressures of the first and second gases in the mixture in the mixing chamber.

13. The device of claim 12, further comprising a controller configured to receive partial-pressure data from the partial pressure analyzer and to establish, at least, predetermined partial pressures of the first and second gases in the mixture in the mixing chamber in response to the data.

14. The device of claim 11, wherein:
the gas-discharge portion comprises a nozzle;
the nozzle is coupled to the pressure chamber and configured to produce the stream of filter gas as filter gas in the pressure chamber is discharged from the nozzle; and
the pressure chamber is configured as a stagnation chamber upstream of the nozzle.

15. The device of claim 11, wherein the mixing chamber includes a temperature-regulating device operable to establish and maintain a preselected temperature of the filter gas in the mixing chamber.

16. The device of claim 11, wherein:
the filter gas comprises at least the first gas and a second gas;
the mixing chamber comprises a first chamber that receives the first gas and a separate second chamber that receives the second gas;
the first and second chambers are pneumatically coupled to the pressure chamber; and
the first and second chambers each comprise a respective partial pressure analyzer sensitive to the first and second gases, respectively, and operable to determine respective partial pressures of the first and second gases, respectively, in the respective first and second chambers for delivery to the pressure chamber.

17. The device of claim 1, further comprising a gas-collection portion coupled to the interaction portion to collect gas of the stream that has passed through the interaction portion.

18. The device of claim 17, wherein the gas-collection portion comprises a vacuum pump.

19. The device of claim 1, wherein:
the at least one wavelength of electromagnetic radiation is an extreme ultraviolet (EUV) wavelength;
the first attenuating gas attenuates the at least one EUV wavelength; and
at least a portion of the EUV wavelength is attenuated by passage of the beam through the stream.

20. The device of claim 19, wherein:
the filter gas comprises a mixture of the first attenuating gas and at least one transmitting gas;
the first attenuating gas is xenon gas; and
the transmitting gas is selected from the group consisting of argon, helium, neon, krypton, and mixtures of at least two of these gases.

21. The device of claim 1, wherein:
the stream of filter gas produced by the gas-discharge portion has a supersonic velocity through the interaction portion;
the supersonic stream produces a shock wave in the interaction portion; and
the interaction portion includes at least one feature situated relative to the stream and configured to displace the shock wave from the beam passing through the stream.

22. The device of claim 1, wherein the beam has an intermediate focus plane that is situated in the stream as the beam passes through the stream.

23. The device of claim 22, wherein:
the stream has a stream axis;
the beam has a beam axis;
the beam axis is normal to the stream axis; and
the intermediate focus plane is situated in the stream substantially at an intersection of the beam axis and stream axis.

24. A gaseous filter device for attenuating a beam of electromagnetic radiation including extreme ultraviolet (EUV) light, the device comprising:
a first mixing chamber coupled to receive a first gas that attenuates propagation of EUV light;
a partial pressure analyzer connected to the first mixing chamber configured to produce data indicative of a respective partial pressure of at least the first gas in the first mixing chamber;
a controller coupled to receive the data from the partial pressure analyzer and to regulate input of at least the first gas into the first mixing chamber based on the data to produce a selected mixture of gases in the first mixing chamber; and
a gas-discharge nozzle coupled to the first mixing chamber so as to receive the mixture of gases from the first mixing chamber and to discharge a flow of the mixture such that the beam of electromagnetic radiation passes through the discharged flow; and
wherein at least a portion of the EUV light of the beam is attenuated by passage of the beam through the discharged flow.

25. The device of claim 24, wherein the nozzle discharges the mixture of gases as a supersonic stream.

26. The device of claim 24, further comprising:
first and second gas-delivery sensors connected to the partial pressure analyzer and configured to sense delivery of first and second gases, respectively, to the first mixing chamber; wherein
the data produced by the partial pressure analyzer is based on respective gas deliveries sensed by the first and second gas-delivery sensors, and
the controller is configured to determine, based on the data, respective amounts of the first and second gases to be delivered to the mixing chamber.

27. The device of claim 24, wherein:
the mixing chamber further comprises a heater;
the partial pressure analyzer includes at least one residual gas analyzer; and
the controller is configured to regulate the heater based on data received from the partial pressure analyzer to produce the selected mixture having at least a selected temperature.

28. The device of claim 24, wherein the mixing chamber comprises:
a temperature sensor; and
a heater/cooler coupled to received data from the temperature sensor and configured, in cooperation with the temperature sensor, to regulate temperature of the mixture of gases in the mixing chamber.

29. The device of claim 24, further comprising a pressure chamber coupled downstream of the mixing chamber and configured to receive the mixture of gases from the mixing chamber, the pressure chamber being connected to the gas-discharge nozzle to deliver the mixture of gases to the gas-discharge nozzle.

30. The device of claim 29, wherein the pressure chamber provides a stagnation condition of the mixture of gases before the mixture enters the gas-discharge nozzle.

31. The device of claim 24, further comprising a second mixing chamber configured to receive a second gas that is transmissive to EUV light; and
a partial pressure analyzer connected to the second mixing chamber and configured to produce data indicative of a respective partial pressure of at least the second gas in the second mixing chamber; wherein
the controller is coupled to receive the data from the partial pressure analyzer of the second mixing chamber and to regulate input of at least the second gas into the second mixing chamber based on the data to produce a selected mixture of gases in the second mixing chamber; and
the gas-discharge nozzle is coupled to the first and second mixing chambers so as to receive and discharged the respective gases from the first and second mixing chambers such that the beam of electromagnetic radiation passes through the discharged flow.

32. The device of claim 31, wherein:
the gas received in the first mixing chamber comprises xenon; and
the gas received in the second mixing chamber is selected from the group consisting of argon, helium, neon, krypton, and mixtures thereof.

33. The device of claim 31, further comprising a pressure chamber coupled to receive respective gases from the first and second mixing chambers, to produce a mixture of said gases, and to deliver the mixture to the nozzle for discharge by the nozzle.

34. The device of claim 31, wherein each of the first and second mixing chambers comprises a respective temperature-control device configured to control temperature of the respective gas mixtures in the first and second mixing chambers.

35. The device of claim 24, further comprising a gas-collection device situated downstream of the gas-discharge nozzle to collect gas discharged by the nozzle.

36. The device of claim 35, further comprising an interaction chamber situated upstream of the gas-collection device, the interaction chamber containing a stream of gas discharged by the nozzle and providing a location where the beam can interact with the stream.

37. The device of claim 36, wherein:
the nozzle is configured to discharge the mixture of gases as a supersonic stream in the interaction chamber; and
the interaction chamber comprises at least one feature situated relative to the supersonic stream to displace a shock wave, associated with the supersonic stream, away from the beam as the beam interacts with the supersonic stream.

38. The device of claim 35, wherein the gas-collection device is coupled to a vacuum pump configured to evacuate the interaction chamber to a selected vacuum level.

39. An extreme ultraviolet (EUV) optical system, comprising:
a first optical system portion situated relative to a source and configured to route an EUV-containing light beam from the source; and
a gaseous neutral density filter located relative to the first optical system portion to receive the beam from the first optical system portion, the gaseous neutral density filter comprising a gas-discharge portion and a gas-radiation interaction portion, the gas-discharge portion being pneumatically coupled to a source of a filter gas comprising a first attenuating gas that attenuates at least one wavelength of EUV light, the gas-discharge portion being configured to produce a stream of the filter gas; and the gas-radiation interaction portion being coupled to the gas-discharge portion to receive the stream of the filter gas, the stream of filter gas propagating in a direction such that the beam traverses the stream in the interaction portion and is attenuated by the stream as the beam passes through the stream.

40. The optical system of claim 39, further comprising a second optical system portion situated to receive the attenuated beam and to direct the attenuated beam to a downstream reticle.

41. The optical system of claim 40, wherein the gas-discharge portion comprises a nozzle from which the stream of filter gas is discharged.

42. The optical system of claim 41, wherein the nozzle is configured to produce a supersonic stream of the discharged filter gas.

43. The optical system of claim 41, wherein:
the gas-discharge portion comprises at least a first chamber, the first chamber being pneumatically coupled to the nozzle and at least to a source of the first attenuating gas of the filter gas; and
the first chamber is configured to regulate a condition of gas, including at least the first attenuating gas, in the first chamber before delivery of the gas to the nozzle.

44. The EUV optical system of claim 43, further comprising a stagnation chamber coupled downstream of the first chamber and configured to receive the gas, with regulated condition, from the first chamber and to provide a stagnation condition of said gas before delivery of the gas to the nozzle.

45. The system of claim 43, wherein:
the gas-discharge portion comprises a second chamber pneumatically coupled at least to a source of a second gas of the filter gas and also coupled to the stagnation chamber;
the second chamber is configured to regulate a condition of at least the second gas in the second chamber; and
the stagnation chamber allows the at least the second gas, delivered thereto from the second chamber, to mix with the first attenuating gas, delivered thereto from the first chamber, and thus form the filter gas discharged from the stagnation chamber through the nozzle.

46. A source of EUV light, comprising:
a generating device that generates EUV-containing light; and
a gaseous neutral density (ND) filter situated downstream from the generating device, the ND filter comprising a chamber and gas-discharging nozzle, the chamber being connected to a source of an EUV-attenuating gas to receive the EUV-attenuating gas from the source and to discharge a stream of the EUV-attenuating gas from the nozzle into the chamber in a direction allowing the EUV-containing light from the generating device to pass through the stream and be attenuated by the stream.

47. The source of EUV light of claim 46, wherein the nozzle is configured to discharge the EUV-attenuating gas at a supersonic velocity.

48. The source of EUV light of claim 46, wherein:
the chamber is also connected to a source of EUV-transmissive gas; and
the EUV-attenuating gas as discharged from the nozzle is mixed with the EUV-transmissive gas.

49. A method for producing a dose of electromagnetic radiation, comprising:
generating a beam of electromagnetic radiation comprising extreme ultraviolet (EUV) light;
producing a stream of a gas comprising an EUV-attenuating gas; and
passing the beam through the stream of gas to attenuate at least a portion of the EUV light of the beam and thereby produce a first dose of the electromagnetic radiation.

50. The method of claim 49, wherein producing the stream comprises producing a supersonic stream of the gas.

51. The method of claim 49, wherein producing the stream comprises:
producing a first gas mixture comprising a first controlled amount of the EUV-attenuating gas and a first controlled amount of at least one EUV-transmissive gas, the first controlled amounts being appropriate for providing a first attenuation of the EUV of the beam;
discharging the first gas mixture through the nozzle as a stream of gas; and
passing the beam through the stream of gas to produce the first dose of the electromagnetic radiation.

52. The method of claim 51, wherein:
the first gas mixture has a first total pressure; and
the respective amounts of the EUV-attenuating gas and the at least one EUV-transmissive gas are respective partial pressures of the first total pressure.

53. The method of claim 51, further comprising:
producing a second gas mixture comprising a second controlled amount of the EUV-attenuating gas and a second controlled amount of at least one EUV-transmissive gas, the second controlled amounts being appropriate for providing a second attenuation of the EUV of the beam;
discharging the second gas mixture through the nozzle as a stream of gas; and
passing the beam through the stream of gas to produce a second dose of the electromagnetic radiation.

54. The method of claim 53, wherein:
the second gas mixture has a second total pressure; and
the respective amounts of the EUV-attenuating gas and the at least one EUV-transmissive gas are respective partial pressures of the second total pressure.

55. The method of claim 51, further comprising regulating a temperature of the first gas mixture to change the respective partial pressures of the EUV-attenuating gas and the at least one EUV-transmissive gas to be different from the respective partial pressures of the first gas mixture; and
passing the beam through a stream of the first gas mixture having the changed respective partial pressures.

56. The method of claim 51, further comprising adjusting a pressure of the EUV-attenuating gas before producing the stream.

57. The method of claim 49, wherein producing the stream of gas comprises discharging the EUV-attenuating gas through a nozzle, the method further comprising heating or cooling at least a portion of the nozzle as the nozzle is discharging the gas.

58. The method of claim 49, further comprising using the gas stream to entrain and remove contaminants approaching the stream from an upstream source.

59. An apparatus, comprising:
means for generating a beam of electromagnetic radiation comprising EUV light; and
means for producing a supersonic stream of EUV-attenuating gas; and
means for directing the beam of electromagnetic radiation through the stream of EUV-attenuating gas to attenuate at least a portion of the EUV light of the beam.

60. A method for attenuating at least one wavelength of extreme ultraviolet (EUV) light in a beam of electromagnetic radiation including the wavelength, the method comprising:
producing a stream of a gas including an EUV-attenuating gas; and
passing the beam through the stream of gas to attenuate at least a portion of the EUV light of the beam.

61. The method of claim 60, wherein producing the stream comprises producing a supersonic stream of the gas.
